(19) United States
(12) Patent Application Publication
(10) Pub. No.: US 2020/0284148 A1
(43) Pub. Date: Sep. 10, 2020

(54) POSITIVE DISPLACEMENT HEAT MACHINES WITH SCAVENGING

(71) Applicants: Alexander BINDER, Haifa (IL); Avraham NAHMANY, Haifa (IL)

(72) Inventors: Alexander BINDER, Haifa (IL); Avraham NAHMANY, Haifa (IL)

(21) Appl. No.: 16/761,256

(22) PCT Filed: Nov. 20, 2018
(86) PCT No.: PCT/IL2018/051251

§ 371 Date: May 3, 2020

(30) Foreign Application Priority Data
Nov. 21, 2017 (IL) 255807

(51) Int. Cl. F01B 7/20; F01C 1/348; F01C 21/10; F02B 53/04; F04B 35/00

(52) U.S. Cl. CPC F01B 7/20; F01C 1/348; F02B 2075/025; F02B 53/04; F04B 35/002; F01C 21/10

(57) ABSTRACT

A high efficiency positive Displacement Heat Machines, for applications such as engines with external heating, Internal Combustion Engines with reduced dirty emissions, heat pumps for ecology clear coolers or heaters, working with air from any source of mechanical energy, thermal processes with approximately constant pressure using an external High and Low Pressure Chambers (HPC and LPC that may be the Atmosphere) that are connecting to a Working Chamber (WC) correspondingly at the end of compression and expansion stages. The disclosed engines and heat pumps operate with displacing at least a part of the WF between said WC and HPC, without changing volume of the WC; with Pulse Pause Modulation of crankshaft speed; with remote expander for engine or compressor for heat pump. The expander or compressor are arranged without transferring mechanical work from another parts of the heat machine. The expander is used as power output from the engine, and the compressor is used as power input to the heat pump.

### FIELD OF INVENTION

The invention relates to a positive displacement heat machines. More particularly the invention relates to a positive displacement heat machine for applications such as:
Heat pumps for ecology clear coolers or heaters, high COP, no refrigerant, working with any gas in closed or open cycle from any source of mechanical energy, for example wind.
Engines with external heating, for example by concentrated Sun light.
Engines with internal combustion and reduced emission of dirty products, capable of burning a wide variety of fuels;
   for transport, engines with high compression and small weight, efficiency 50-60% for every working mode;
   for transport and power plant, with low compression and regeneration, efficiency more 60% for every working mode.

### BACKGROUND OF INVENTION

### Description of Prior Art

1. U.S. Pat. No. 4,333,424A discloses an Internal combustion engine which has a compressor which compresses air for delivery via a heat exchanger to an expander. The expander receives the compressed air and fuel and, while combustion occurs during a power stroke, the air pressure is reduced to atmosphere and the expander drives a crankshaft. The fuel is injected at a rate to maintain the air temperature at the entry temperature. The exhaust passes through the heat exchanger to heat the incoming flow of compressed air to the expander. Energy may be stored via the crankshaft or used directly (The description recites: “The compressor 40 has two stages 43, 44 with an intercooler 45 there between.”, “ . . . the compression is assumed to take place isothermally . . . ”; “ . . . . Both the large crankshaft and the large flywheel can also be eliminated by using the expander to drive a hydraulic pump which in turn drives a small hydraulic motor connected to a small crankshaft and flywheel rotating in unison at high speed . . . . This crankshaft also drives a high speed compressor as well as the load.”).

Problems of U.S. Pat. No. 4,333,424A

Thermodynamic cycle of this engine give the same large efficiency as cycle Carnot, if compressor is isothermal; efficiency no depend from compression ratio. Mentioned two stages compressor with intercooler may approximate the isothermal compression, but cause addition vortex and friction loss. If compression ratio is small, for example, kp=2, a single stage compression is near isothermal, but the small kp cause large size cylinders of compressor and expander and so large loss caused by transfer energy between compressor and expander with crankshafts or hydraulic means, Any case, this engine have a small ratio power/volume and so large weight and inertial forces, that make it very sensitive to friction loss in crankshaft bearings and to vortex loss. For this and another prior art with crankshaft, regulation to a small rotation moment (load) diminish efficiency, so as part of friction loss, caused by inertial forces, no depend from the load; regulation to a small rotation speed with gear increase friction loss, and regulation with hydraulic means cause vortex loss.

2. U.S. Pat. No. 4,369,623, discloses an engine with positive displacement piston chambers, an external combustion chamber from which combustion gases pass . . . to piston chambers, an air compressor, a heat exchanger where exhaust gases from the piston chambers preheat compressed air which then flows to the combustion chamber, and an accumulator for storing . . . compressing air from the compressor . . . . (The description recites: “FIG. 1 . . . preferred embodiment . . . different pistons form the air compressor and the power unit.”, “high pressure gases . . . force . . . pistons 48 . . . connected to a crankshaft 58 . . . Pistons 12 of the air compressor are also connected to the crankshaft 58.”, “FIG. 2 . . . in which the same pistons . . . function as a compressor during one stroke of the cycle and during the other strokes is driven by the hot gases from the combustion chamber.” From Claim 1: “ . . . for allowing compressed air to exit said displacement chamber . . . during about each fifth stroke of said piston during the normal steady state mode of the engine; . . . ”).

Problems in U.S. Pat. No. 4,369,623

Friction loss, caused by transfer energy with crankshaft. Regulation by compression “during about each fifth stroke” cause pulsation of pressure in the combustion chamber and so diminish efficiency. For this and another mentioned below prior art with crankshaft, regulation to a small rotation speed increase thermal loss to wall of cylinder and to piston.

3. U.S. Pat. No. 7,281,383 discloses a four stroke Brayton refrigerator or heat engine which is a thermal machine that can function as either a refrigerator or an external combustion heat engine . . . Bravton cycle . . . adiabatic compression and adiabatic expansion, take place in the same cylinder, within which a piston, driven by a crankshaft, reciprocates. The remaining two processes, each of which is a transfer of heat at constant pressure, take place in a high pressure heat exchanger and a low pressure heat exchanger. A rotary valve . . . creates passages between the cylinder and the heat exchangers, and is constructed so that compression and expansion ratios are equal.” From description: “ . . . conditioner according to a basic embodiment (Tc=16 C, Th=32 C, nitrogen refrigerant, P(low)==23 bar) gives cycle C.O.P.=8.03.”; “Th=Temperature at the outlet of heat exchanger H, . . . Tc=Temperature at the outlet of heat exchanger L”.

(“L” to cool a room air, “H” to cool compressed air. No examples for temperatures at inputs of the heat exchangers.)

Problems in U.S. Pat. No. 7,281,383 B2

For good efficiency, compression and expansion ratios must be equal; the rotary valve, constructed for it, cause a vortex loss. For engine, volume after expansion is more, than before compression, for heat pump—vice versa, so both cases, part of the cylinder volume is not used, that increase friction loss in crankshaft bearings. Part of piston stroke is used for displacing compressed gas between the cylinder and heat exchanger “H”, that increase loss in piston sealing and crankshaft bearings; near a dead point, no any useful process, but crankshaft bearings rotating under maximum pressure that cause addition friction loss. During begin output to “H” and end input from “H”, surfaces of openings are small, so velocity of gas is large that cause addition vortex loss. Large velocity current of hot gas during input increase loss of heat to surface of the cylinder. Due to parasite volume of the cylinder, part of compressed gas no make useful work. This part, mixing with a hot input gas, diminishes maximum temperature of a cycle, so diminish efficiency and power. If volumetric compression is 10 and the parasite volume is 1% of maximum volume of WC, 10% of gas no work.

A problem of any heat machine is: when Energy of Compression (EC) is close to Energy of Expansion (EE), the heat machine is very sensitive to loss during compression and expansion, so to the vortex and friction loss. Suppose, that conditioner work with open Brayton adiabatic cycle and get air from a room with Tbc=27° C.=300° K; This air is compressed to Tec=317° K, so kt=1.057, then cooled in heat exchanger “H” to Tbe=305° K, then expanded in the cylinder to Tee=Tbe/kt=289° K, then mixed with a room air. If no loss, COP=289/(305−289)=18. Compression and expansion are between the same pressures, so EC/EE=Vbc/Vee=Tbc/Tee=1.038. If EE=100 J, EC=103.8 J, no loss: MW=EC−EE=3.8 J. If efficiency of compression and expansion is 0.97: MW=103.8/0.97−100*0.97=10 J. So, really COP=18*3.8/10=6.8<<18, even with ideal heat exchanger. In the prior art with preferable closed system, C.O.P. is good due to large Pbc=“P(low)===23 bar”, so, mechanical efficiency and volumetric power of cylinder are better, then for the open system. But, the closed system have disadvantages comparing to the open system: large sizes and cost of heat exchangers; heat exchanger “L” is a source of infection, collected on a large wet surface; temperature at input of “L” is smaller, then Tee in open system, that diminish COP; temperature Tc at output of “L” is smaller, then Tbc, that diminish heat power, EC/EE is closer to 1 and the system is more sensitive to loss during compression and expansion; possible leak. The vapor compression refrigerators, that are in common use, include the same problems. Open system no have this problems, but friction loss in bearings of crankshaft and piston rings, vortex loss in the rotary valve, make the open system no practical for conditioner. So, the problems are vortex and friction loss, and in addition for closed system: possible leak, diminish COP and possible infection, larger cost and size, caused by heat exchanger “L”.

4. U.S. Pat. No. 8,360,759 Discloses a Rotary Engine Flow Conduit Apparatus and Method . . . .

It describes an Internal Combustion Engine (ICE) with vanes, moving in slots of eccentric rotor, with using slots to displace air between atmosphere and working chambers, that are between vanes, rotor and housing.

Problems in U.S. Pat. No. 8,360,759B2:

Friction loss by vanes, vortex loss inside slots, a short time for combustion—a common problem for Internal Combustion Engines. large loss of heat to surfaces of WC—a common problem for rotor engines.

5. US20070199299A1 discloses a combustion engine that has at least a plurality of power strokes during a complete cycle . . . piston—cylinder arrangement is used to compress air and deliver it to a combustion chamber . . . ” (From description: “ . . . two . . . eight or even more power strokes . . . ”; “[0021] Valve control . . . to optimize compression, combustion, expansion and exhaust during engine operation”; “Piston displacement is translated by a connecting rod linking it to a crankshaft into rotary power engine output”).

Gist: the same cylinder with several working strokes for single compression stroke; or mixing, with several cylinders, one

only for working strokes [0025]; transfer energy by crankshaft.

Problems in US20070199299A1 are the same that mentioned above for [2] U.S. Pat. No. 4,369,623.

6. DE102009049974 discloses a heat engine device for converting heat into mechanical work that has two stroke piston engines with one or multiple cylinders and crank shaft. It comprises “ . . . a two stroke piston engine with one or multiple cylinders and a crank shaft. A cool working gas is supplied into an area over a piston . . . compressed during the piston movement . . . pushed in an external heater . . . .”

Problems in DE102009049974 A1: About increased friction, vortex and thermal loss in prior art EHE during displacing compressed gas, see explain to prior art 3.

7. WO1998057038 discloses a Multi vane rotary piston engine, in which the compressed air is introduced in the combustion space through outlets on the side covers, while the exhaust gases are introduced, through outlets on the side covers, . . . .”

Problems in WO1998057038 A1: the vanes are moving inside slots under pressure force, that cause friction loss. The outlets are in side covers, so with increasing length of the rotary piston engine, increasing vortex loss. Optimal Vee/Vbc is only for a single working mode, else part of expansion energy will be lost.

8. WO2011046975 discloses a hydraulic internal combustion engine with “ . . . at least one combustion piston . . . acting on hydraulic plungers through valving to control the piston position and velocity . . . ”. It is a free piston engine with Pulse Pause Modulation (PPM).

Problems in WO2011046975 A1: Hydraulic valves, used for the PPM and another purposes, cause addition vortex loss. A short time for combustion, is a common problem for ICE, and it is very short for the free piston engine, that may cause dirty “Output products” (see GLOSSARY . . . ). Partly loss of expansion energy that is a common problem for prior art machines with the same working chamber for compression and expansion of all working fluid.

9. Peter A. J. . . . “Horsepower with brains: The design of the CHIRON Free Piston Engine” (Society of Automotive Engineers, Inc., January 2000) discloses a free piston engine with PPM, with the same problems, as for prior art 8.

### Summary of Prior Art Problems

At a partly power, that is most used mode for transport, engine efficiency may be twice smaller, than at optimal mode; see explain to prior art 1 and 2.
In engines, must Vee>Vbc, else part of expansion energy will be lost, see prior art 2, 3, 7, 8, 9. In prior art 2, “each fifth stroke” used for compression: Vee=5*Vbc, that diminish efficiency, as mentioned for prior art 2.
Short time for combustion in ICE causes a bad combustion with ecology dirty emissions.
Prior art with increasing vortex moving for better combustion, have more vortex loss and loss of heat.
EHE, designed to use combustion energy, have large external combustion chamber (see “HPC”) and so a large time for mixing and combustion, but prior art have increased friction, vortex and thermal loss during displacing compressed gas by piston, see explain to prior art 3.
Regulation to a small load or small rotation speed diminish efficiency, see prior art 1, 2.
Free piston engines have hydraulic loss, loss of expansion energy, short time for combustion—see prior art 8, 9.

### List of Prior Art Problems

Loss of efficiency at partly power. Partly loss of expansion energy. Friction loss in bearings of crankshaft, by piston rings, by vanes. Vortex loss in valves and cylinder. In ICE, short time for combustion. Loss of heat to surfaces of WC. In EHE, parasite volume of the WC, and addition (comparing to ICE) friction, vortex, and thermal loss.

Description of this problems see above and solving by this invention see below.

It is therefore an object of the present invention to provide a method of operating a Positive Displacement Heat Machine, which overcomes the drawbacks of prior art.

Other objects and advantages of this invention will become apparent as the description proceeds.

### SUMMARY OF THE INVENTION

A method of operating a Positive Displacement Heat Machine (PDHM), the PDHM provided with at least a single Working Chamber (WC), arranged to change its volume during at least a part of a thermodynamic cycle and to transfer mechanical energy to/from a compressible Working Fluid (WF); the thermodynamic cycle including compression and expansion entailing Lower Pressure (LP) of the WF; the thermodynamic cycle further including Higher Pressure (HP), HP>LP; the thermodynamic cycle also including a Lowest Temperature (LT) of the WF; the thermodynamic cycle further including a High Temperature (HT), HT>LT; the PDHM is further provided with at least a single Low Pressure Chamber (LPC, 40), containing the WF with the LP; the LPC may be the atmosphere, otherwise the LPC is provided with means, arranged for thermal transfer between the LPC and an external medium; the LPC is provided with an LPC Input Part (LPCIP) for the WF and an LPC Output Part (LPCOP) for the WF with changed temperature; at least a single Low Pressure Input Mean (WCLPIM, 20) is provided between the WC and the LPCOP, and at least a single Low Pressure Output Mean (WCLPOM, 21) is provided between the WC and LPCIP, both arranged as controllable openings; the PDHM providing with at least a single High Pressure Chamber (HPC, 8), that contains the WF with the pressure HP; if the PDHM is the heat pump, the HPC 8 arranged for cooling the WF by heat transfer to external medium; at least a single High Pressure Controllable Opening (WCHPCO, 18) is provided between the WC and HPC; the thermodynamic cycle comprising:
1.1. moving at least a part of the WF from the WC to the LPCIP across the WCLPOM 21;
1.2. moving at least a part of the WF from the LPCOP to the WC across the WCLPIM 20;
1.3. changing a temperature of the WF in the LPC 40, and/or in the WC, and/or in the HPC 8;
1.4. compressing the WF in the WC with closed WCLPOM 21, WCLPIM 20, WCHPCO 18;
1.5. moving the WF across the WCHPCO 18;
1.6. expanding the WF inside the WC with closed WCHPCO 18, the method is characterized in that:

during step 1.5, after ending compression in the WC, and when pressure in the WC is close to pressure in the HPC 8, opening the WCHPCO 18 and displacing at least a part of the WF between the WC and HPC 8, such that displacement of the part is not caused by changing the volume of the WC.

A two stroke reciprocating piston engine apparatus, comprising:

a) at least single thermally isolated High Pressure Chamber (HPC) 8 with Working Fluid (WF) compressed to High Pressure (HP), volume of the HPC 8 is sufficiency more, than end compression volume Vec;

b) at least single Cylinder 15 with two Assemblies 16, each Assembly includes:

b.1) two Crankshafts having minimal Inertial Moment, each Crankshaft is not connected to external load;

b.2) a Piston, connected to a central part of a Beam;

b.3) a Buffer 51, connected to central part of the Beam opposite to the Piston, for accumulating Energy from Expansion (EE) of WF (gas) during working stroke of the Piston, and return the EE during compression stroke as Energy for Compression (EC), while EE and EC are approximately the same, EE=EC;

b.4) two connecting rods, one side of every connecting rod connected with bearing to a tip of the Beam, and another side with another bearing connected to corresponding Crankshaft being connecting to a synchronization gear; the crankshafts are arranged to rotate to opposite directions due to the gears; at least one of the crankshafts with addition gear and synchronization Belt connected to corresponding crankshaft of another the Assembly;

c) the two Assemblies 16, are arranged such, that:

c.1) symmetrically moving each of the two Pistons inside the Cylinder 15 between High Pressure Dead Point (HPDP), that is near a central part of Cylinder 15, and a Low Pressure Dead Point(LPDP), that is near a tip of Cylinder 15, so in Cylinder 15 there are two the HPDPs and two the LPDPs;

c.2) symmetrically moving all parts, such that inertial forces are balanced;

c.3) symmetrically loading all parts by gas forces, such that there are no forces between the pistons and Cylinder 15;

c.4) volume (Vmin) between the two HPDP is equivalent or smaller than the Vec, such that the pistons are not displacing all compressed WF to the HPC 8, thereby diminishing moving pistons under the HP;

c.5) Assemblies 16 and all rotating means in it or connected to it, including the Belt, have a minimum Inertial Moment, limited only by mechanical strength, but the Reciprocating Parts in the Assemblies 16 may have a large mass, thereby diminishing dynamic load on the bearings;

d) a Working Chamber High Pressure Controllable Opening (WCHPCO) 18 in the central part of Cylinder 15, between two the HPDP, the WCHPCO 18 arranged to control a flow of WF between the Cylinder 15 and HPC 8, such that:

d.1) the flow begins after ending compression and when the pressure in Cylinder 15 is approximately equivalent to the HP;

d.2) the flow ends when volume in the Cylinder 15 is increased to Vbe, and Vbe is equivalent or more than the Vec;

e) a fuel Injector 25A between two the HPDP, remote from the WCHPCO 18; the Injector 25A arranged for combustion after end compression, such that:

e.1) after opening the WCHPCO 18, displacing at least a part of compressed WF to the HPC 8 due to heat expansion of combusted product, thereby diminishing moving of the Piston under the HP;

e.2) minimum mixing between the displacing part and the combusted product;

e.3) preferably ending combustion before expanding to the Vbe;

f) a sensor HPCIMTS 27, arranged to measure temperature T27 of the WF in the HPC 8 after the WCHPCO 18;

g) a Remote Expander 19, arranged as power output of the engine, without transferring energy from, or to, Assembling 16, with expansion from the HP to Atmospheric pressure;

h) at least a single Electrical Machine 22, mechanically connected to any of the Crankshafts, for receiving energy, for providing energy, arranged to control rotation of the Crankshafts, the power of the Machine 22 is sufficiency smaller, than the power of the Expander 19;

i) a Rotating Speed and position Sensor (RSS) 31, mechanically connected to the Electrical Machine 22 or to the Crankshaft;

j) a pressure sensor HPCPS 32, arranged to measuring differential pressure between HPC 8 and Atmosphere;

k) a Controller 29, arranged to:

k.1) control the WCHPCO 18 and Injector 25A, such that EE=EC, with using feedback from the RSS 31;

k.2) control the WCHPCO 18 and Injector 25A, such that if need fast changing of mean speed of the Crankshaft, EE>EC, or EE<EC according to desired changing;

k.3) control the Electrical Machine 22, such that kinetic energy of the Assembling 16 at position according to at least one of the HPDP or LPDP, will be desired volume, including zero, with using for this control feedback from the RSS 31;

k.4) if the speed of the Crankshaft near at least one of the HPDP or LPDP is near zero, optionally fixating the Assembling 16 during desired Fixation Time, using the Electrical Machine 22 for this fixation;

k.5) initiating moving of the Crankshaft with the Electrical Machine 22;

k.6) synchronization the mean cycle speed of Assembling 16 with throughput of the Expander 19, such that the pressure HP in the HPC 8, measured by the HPCPS 32, will be as desired;

k.7) controlling the Injector 25A and WCHPCO 18 for minimum mixing, mentioned in e.2, with using signal from the RSS 31 and HPCIMTS 27; for optimal case, T27 is not sufficiency more, than temperature at end compression Tec;

k.8) controlling the Injector 25A and WCHPCO 18, such that pressure at the end, expansion will be not substantially more than Atmospheric pressure;

l) at least a single Fuel Injector 25B, preferably inside the HPC 8, and optionally in Expander 19.

In heat machine (see explain to prior art 3) take place compression process that get energy EC, and expansion process that give energy EE. Efficiency of compressor Efc<1, expander Efe<1. For engine, EE>EC, for heat pump, EE<EC. Mechanical Work from engine or input work for heat pump is: MW=EE*Efe−EC/Efc. For heat pump MW<0.

Main principle (gist) of the present invention is to make Efc, Efe close to 1, by another words, diminishing the loss, caused by circulation energy inside heat machine.

Combination of principles, explained below, give the best result. In most embodiments used all principles.

Gist: Displacing at Least a Part of the WF Between Said WC and HPC, without Changing Volume of the WC.

The gist includes scavenging between the WC and HPC, and combustion at least a part of fuel outside the WC.

Are embodiments with combustion a part of fuel inside the WC, so pushing any part of WF to the HPC.

### Advantages for ICE, EHE and Heat Pump

Smaller stroke of piston and so smaller friction loss, against prior art, where compressed gas is displaced by piston;
part of cylinder with high P is not in contact with piston and may be optimal T of this part to diminish thermal transfer.
Smaller vortex and so smaller thermal loss. Minimum volume of WC may be (maximum volume)/kv, so possible to make a good aerodynamic shape of piston and large valves in wall of cylinder; in prior art, this minimum volume prefer to be zero, and named a “parasite” volume. So, no mentioned problems caused by the “parasite” volume.
Possible opposite pistons in the same cylinder without head (so smaller heat loss), with valves in a wall of the cylinder.
Smaller compression work. If used the buffer (51) for this work, smaller size of it and so smaller friction loss.
So as smaller stroke of piston, diminish size, mass and inertial moment of crankshaft, that cause the best realization of Pulse Pause Modulation (PPM, see below), diminish friction loss caused by inertial forces.
Combustion of all or most fuel take place in HPC, so may be a short time when a hot pressured gas is in the WC, so smaller thermal loss.

### Gist: Pulse Pause Modulation (PPM) of the Crankshaft Speed, that Include Possibility for Reducing Rotation Speed Approximately to Zero at Least Near One Dead Point (DP) and Fixation of Crankshaft in this DP

### Advantages for ICE, EHE and Heat Pump

Regulation of cycles per second from zero, with maximum efficiency at every load. This regulation may be very fast, that is most important, if for power output used addition expander (see below), working according to demands of load.
Small load and friction in crankshaft bearings, caused by PPM and by small inertial moment of crankshaft.
Regulating a time for optimal combustion and small thermal loss.
Regulating a time for displacing WF between WC and HPC and WC and LPC, that diminish vortex and thermal loss.
If transfer energy by hydraulic means, smaller loss, so as may use automatic valves, against the free piston prior art with controllable valves.

### Gist: Providing Expander or Compressor, Arranged without Transferring Energy from or to ECM (See GLOSSARY), Using the Expander as Output of at Least a Part of Power of the Engine, or Using the Compressor as Input of at Least a Part of Power of the Heat Pump

### Advantages for ICE, EHE and Heat Pump

Full expansion in engine, matched compression and expansion in heat pump that increase efficiency.
Smaller friction loss in the WC.
Better arrangement of a full design. For example, in Sun power plant, a large assembling with expander and electrical generator is remote from a small size WC, placed near focus of Sun ray concentrator. This WC may work in hermetic envelope and no transfer energy to external means.

Gist: In the “Multi Vane Rotary Machine”, Scavenging Compressed WF Between the WC and HPC.

Advantages:
Sufficiency smaller stroke of vane, so smaller friction loss.
Vortex loss/power, no increased with length of body, this length is proportional to power.
Optimal Vee/Vbc for every working mode.

### List of Advantages, Comparing to List of Problems

No loss of efficiency at partly power. No loss of expansion energy. Smaller friction loss in bearings of crankshaft, by piston rings, by vanes. Smaller vortex loss in valves and cylinder. In ICE, regulated time for combustion. Smaller loss of heat to surfaces of WC. In EHE, no parasite volume of the WC, and no addition friction, vortex, and thermal loss.

### BRIEF DESCRIPTION OF THE DRAWINGS

FIG. 1A is a Simplified view on the prior art according to [7] WO1998057038 A1.

FIG. 1B: shows a PDHMR according to the present invention, preferable as home conditioner.

FIG. 1C: shows a Version with no circular symmetrical body, so the rotor no load from pressure force.

FIG. 1D: shows a View on body.

FIG. 2A: shows a the ICE, 2 stroke, with remote expander and PPM; displacing a part of the WF from the WC to HPC due to diminishing volume of the WC and due to combustion in it; preferable as engine for car.

FIG. 2B: shows a Changing volume of WC during working cycle.

FIG. 2C: shows a Parameters of working cycle of the engine versus isothermal part of expansion in the expander.

FIG. 2D: shows a Valves WCLPOM, WCLPIM in closed and open position.

FIG. 3A: shows a The ICE for power plant and transport, with PPM, efficiency>63%, with isothermal remote expander and regenerator. It is improvement of prior art [1] U.S. Pat. No. 4,333,424A.

FIG. 3A: shows a The ICE for power plant and transport, with PPM, efficiency>63%, with isothermal remote expander and regenerator. It is improvement of prior art [1] U.S. Pat. No. 4,333,424A.

FIG. 3B: shows a Cycle of engine with regulating input-output time Tio.

FIG. 3C, FIG. 3D, FIG. 3E: show Versions of engine with multistage compressor.

FIG. 4A: shows the EHE for Sun power plant, ISC between the WC and HPC; PPM, remote expander connected to electrical generator.

FIG. 4B: shows Piston and crankshafts assembling 16 with buffer 51, adjusted for PPM.

FIG. 4C: shows Inertial Scavenging (ISC).

FIG. 5A: shows External Combustion Engine (ECE) with hybrid Sun heating and combustion and remote expander.

FIG. 5B: shows Scavenging.

FIG. 6: shows the heat pump for combined heat pumping and producing energy from a wind source.

FIG. 7: shows the ICE, 2 strokes. Distinction from version FIG. 2A is that version FIG. 7 comprises a regulated hydraulic pump as energy receiver, to use no-zero Zwork for charging a hydraulic accumulator. Combined mechanical and hydraulic power need, for example, in construction engineering.

### DETAILED DESCRIPTION OF THE INVENTION

### Glossary and Abbreviations

“Adiabatic process” takes place when no heat transfers. Parameters of adiabatic process:
P, V, T—Pressure, Volume, Temperature (gradus K) of Working Fluid (WF, any gas);
bc, ec—begin, end compression; for example, Pbc, Pec.
be, ee—begin, end expansion.
Cp and Cv—are the thermal capacities of WF when P or V is constant.
ka—the adiabatic coefficient, ka=Cp/Cv; for Air, ka=1.4.
For compression: kv=Vbc/Vec>1; kp=Pec/Pbc=kv^{ka}>1; kt=Tec/Tbc=kv^{(ka-1)}>1.
There, most cases for compression and expansion, parameters kv, kp, kt are the same.
For expansion: kv=Vee/Vbe>1; kp=Pbe/Pee=kv^{ka}>1; kt=Tbe/Tee=kv^{(ka-1)}>1.
W—Work of gas; for expansion and compression, |W| is the same, if Vbc=Vee, Vec=Vbe, Pbc=Pee, Pec=Pbe:

Expansion: W=(Pbe*Vbe−Pee*Vee)/(ka−1)=Pbe*Vbe/(ka−1)*(1−1/kt)>0;

Compression: W=−(Pec*Vec−Pbc*Vbc)/(ka−1)=−Pec*Vec/(ka−1)*(1−1/kt)<0;
EE—is the Energy from Expansion of the gas in the WC, defined as:

EE=W+W(input to expander)−W(work against atmospheric pressure).
CE—Energy for Compression of the WF in the WC, defined as:

CE=W(input to compressor)−W(output from compressor)−W.
MW—Mechanical work; MW=EE−CE. For engine, MW>0; for heat pump, MW<0.
Ef—Efficiency of engine, defined as: Ef=MW/TE, TE is thermal energy.
Efa—Efficiency of engine for adiabatic compression and expansion.

“Brayton adiabatic cycle” consist adiabatic compression and expansion and constant pressure heating and cooling. Engine efficiency: Efa=(Tec−Tbc)/Tec. Heat pump, if cooling: COP=Tee/(Tbe−Tee).

“Blower” (9) implies a separate design or set of parts, arranged to displace the WF inside the heat machine, if for this displacing need a small difference of pressure.

“Components of air” are N₂, O₂, CO₂, H₂O, etc. as they are in a normal air with appropriate concentrations.

“Clear output” implies Output products of engine with CO₂ and H₂O or only H₂O, with concentrations of the dirty output products below than appropriate standard.

“Coefficient of Performance” (see “COP”, “Heat Pump”), this term is used for Heat Pump.

“COP”=Thermal Energy (TE)/Mechanical Work (MW). TE transferred between “cool” and “heat” objects.

“Compressor of inertial type” converts mechanical energy to pressure and kinetic energy of the WF.

“Compressor of positive displacement type” converts mechanical energy to pressure energy of the WF.

“Controllable Opening”: “Controllable” imply any type of control, including, for example, changing position of any mean relatively to the opening; piston may close and open a scavenging window, a valve driver may close or open a valve, the valve may be any type.

“Cylinder” is positive—displacement working chamber in general, not restricted to circular cross-section.

“Dirty output products” are output products of engine, except components of air.

“Efficiency” of the heat engine is Mechanical Work (MW)/Thermal Energy (TE).

“Expander of inertial type” is a Turbine, using compressible WF.

“Expander of positive displacement type”—see “Positive displacement”.

“External heating engine”, have the WC where take place near adiabatic thermodynamic processes. Heat is transferred to external volume that may be a heat exchanger or external combustion chamber.

“Heat machine” convert a part of Thermal Energy (TE) to Mechanical Work (MW) or vice versa (see “Heat pump”).

“Heat pump” uses MW to move TE opposite to spontaneous heat flow; may work as cooler or heater.

“Internal heating engine” (IHE), for example a spark ignition or Diesel type, have a working chamber (WC), for example a space bounded by a piston and a cylinder, where take place thermodynamic processes, including combustion of a fuel inside compressed air.

“Inertial Scavenging” (ISC), see “Scavenging”. Initiating moving a part of a WF from and (or) to WC and continue this moving due to kinetic energy of the WF and, in addition, due to kinetic energy of any mean, if it designed for ISC.

“Local minimum” of a velocity, V1 min, defined there according: V1>V1 min<V2, where V1, V1 min, V2 are velocity points inside any part of cycle at appropriate time points t1<t1 min<t2 with minimum detectable differences V1−V1 min and V2−V1 min. Local minimum of piston speed=0 at ‘dead points’ (crankshaft angles 0° and 180°), and it is absolute minimum as well. The crankshaft rotation speed may have a local minimum after end compression.

“Main shaft”, means the shaft which converts reciprocating piston motion into rotary motion or vice versa.

There, term “crankshaft” means the shaft which converts reciprocating piston motion into rotary motion or vice versa, but “main shaft” means the shaft which converts any motion into rotary motion or vice versa. For example, in “Vankel” engine, planetary motion converted to rotation by main shaft. So, the “main shaft” is wider definition than “crankshaft”.

“Output products” are CO₂, H₂O, CO, NₓO_{y} (for example, NO), etc., depended upon the fuel type and the combustion quality. After ideal combustion of good fuels, output products are CO₂ and H₂O, or only H₂O if Hydrogen (H₂) is used.

Dissociation of N₂ and O₂ begin approximately above 2000° K and increase concentration of NₓO_{y} in output products.

Combustion temperature in prior art ICE is more than 2000° K and is sufficiency more in local volumes if bad mixing.

After cooling, not all NₓO_{y} is decomposed to N₂ and O₂. So, NₓO_{y} in output may be with using every type of fuel.

“Positive displacement”, according to IPC (International Patent Classification), means the way the energy of the WF is transformed into mechanical energy, in which variations of volume created by the WF in the WC produce equivalent displacements of the mechanical member transmitting the energy, the dynamic effect of the WF current being of minor importance.

“Pump”, according to IPC, means a device for raising, forcing, compressing, or exhausting fluid by mechanical or other means. “Pump” includes fans or blowers.

“Scavenging”, according to IPC, means forcing the combustion residues from the cylinders other than by movement of the working pistons, and thus includes tuned exhaust systems. There, term “scavenging” is used not only for the combustion residues and exhaust, and imply displacing at least a part of the WF from the WC and displacing another part of the WF to the WC by any way, that cause essentially more displacing than according to changing volume of the WC during this displacing process, including a case with constant volume of the WC or even changing this volume against direction of this displacing. See above “Inertial Scavenging”, ISC.

“Sterling cycle”, in ideal, includes constant volume heat transfer in regenerator, isothermal compression and expansion, constant volume heating and cooling.

“Turbine” converts kinetic energy of the WF to mechanical energy.

“Working fluid” (WF), according to IPC, means the driven fluid in a pump and the driving fluid in an engine. The WF may be in a gaseous state, i.e., compressible, or liquid. In the former case coexistence of two states is possible. There, term “working fluid” used as well for heat pump. During working cycle in engine or heat pump, the WF may be converted from gaseous to liquid state or vice versa.

### Abbrevations

DP—Dead Point, it is position of crankshaft in reciprocating piston machine, and appropriate position of the piston, where the piston change direction of moving. At the DP, the piston cannot change rotation speed of the crankshaft. For free piston machines, DP is position of piston, where it change direction of moving.
EHE—External Heating Engine.
ECE—External Combustion Engine (ECE is the type of EHE).
HM—Heat Machine, there may be engine or heat pump.
HPDP—High Pressure Dead Point—the DP, where pressure in the cylinder is approximately equivalent to the High Pressure level.
ICE—Internal Combustion Engine.
IPC—International Patent Classification.
ISC—Inertial Scavenging, see above “Scavenging”, “Inertial Scavenging”.
LPDP—Low Pressure Dead Point—the DP, where pressure in the cylinder is approximately equivalent to the Low Pressure level. LPDP is equivalent to the Bottom Dead Center, where scavenging between combustion gas and free air.
PDHM—Positive Displacement Heat Machine.
PDHMR—PDHM with multi vane Rotor.
PPM—Pulse Pause Modulation. Working mode of the PDHM with reciprocating piston, when it may be stopped at the Dead Point and begin moving after a controllable time.
RPC—Reciprocating Piston and Crankshaft, wide using type of the PDHM.

### Abbreviations of Parts

The referenced numbers are from drawings; see section “Numbers of parts for all drawings”.

Buffer (51), a mean that combine functions of Energy Receiver (ER) and Energy Source (ES), see ER, ES. Preferable a gas buffer.
C (7)—Compressor, with input from LPC, output to HPC, a volumetric ratio arranged so, that pressure at end compressing approximately equivalent to HP in HPC; using the compressor as a receiver for at least a part of input power of the heat pump.
E (19)—Expander, with input from HPC, output to LPC, a volumetric ratio arranging so, that pressure at end expanding approximately equivalent to LP; using the expander as a source for at least a part of output power of the engine, with regulating the expander according to demands of a load.

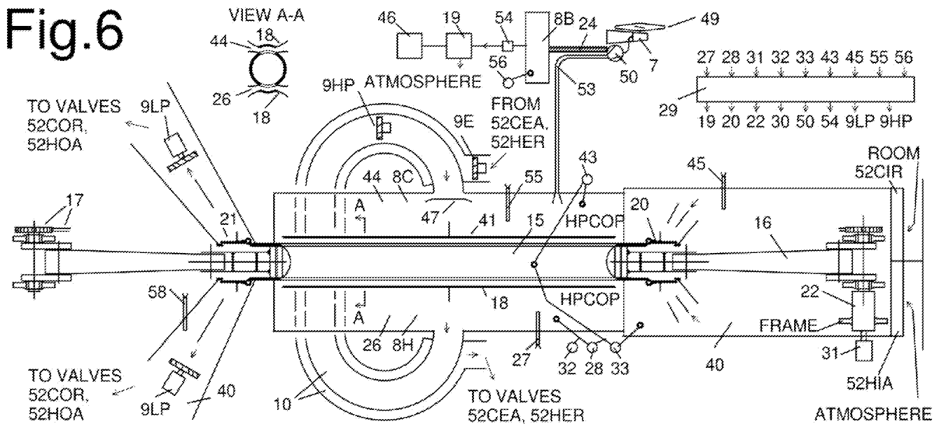

ECM—Energy Conversion Means, arranging to work with at least a part of the WF, used in a thermodynamic cycle of the heat machine, with converting energy of compressed WF to mechanical work, and reverse converting, with conversion algebraic sum of compression and expansion energy to a work, named Zwork; supposing, that expansion work is positive, and compression negative, Zwork<0 is according to receiving external work, Zwork>0 is according to producing output work; all parts, that need to make the Zwork, named Zmachine.
ECM of positive displacement type named Working Chamber (WC);
WC, arranged only for compression, named WCC and is a part of the ECM;
WC, arranged only for expansion, named WCE and is a part of the ECM; the WC may include separated parts WCE and WCC or arranged as a single chamber for both functions.
A part of ECM, converting energy of compressed WF to kinetic energy of moving WF and then to mechanical work, named turbine;
A part of ECM, converting mechanical work to kinetic energy of moving WF and then to energy of compressed WF, named axial or radial compressor according to working principle;
A turbine, mechanically connected to radial or axial compressor, named turbo-compressor.
EIH—Expander Input Heater.
ER—Energy Receiver.
ES—Energy Source. ER, ES may be mechanical, hydraulic, electrical means, or another; separated, or both in the same design. Examples for the same design: electrical machine, hydraulic machine, gas buffer (51), inertial mass. An example for ER is a hydraulic pump with a single direction input and output valves.
FC—Fixation of Crankshaft, a mean to fixate the crankshaft near at least one of Dead Point if the rotation speed near it, is approximately zero;
HA—Hydraulic Accumulator, with separated liquid and compressed gas volumes inside a common envelope with a common high pressure.
HMP—Hydraulic Motor—Pump.
HPC (8)—High Pressure Chamber, include function of pressure buffer volume (it is not buffer 51), heating or cooling.
HPCPS (32)—pressure sensor arranged to react to the HP in the HPC; most cases may be electrical or mechanical output.
HPCBPS (56)—HPC buffer volume pressure sensor. About 32 and 56 see description to FIG. 6.
HPCIM (26)—HPC Input Mean for the WF from WC, include a channel arranged with gradual increasing a transverse section from WCHPCO (see below) 18 to HPC 8, and for the heat engine have a thermal isolation.
HPCIMTS (27)—sensor to measure a mean temperature T27 of the WF in the HPCIM.
HPCOM (44)—HPC Output Mean for the WF to WC, that include a channel between the HPC and the WCHPIM, this channel arranged with gradual decreasing a transverse section from the HPC to WCHPIM, whereby to diminish loss of kinetic energy of the WF, and in the heat engine, the HPCOM is thermal isolated.
HPCIP—Input Part of the HPC.
HPCOP (8OP)—Output Part of the HPC.
HPSDV (47)—Single Direction Valve, that makes possible current inside the HPC from the HPCIP to HPCOP.
ICM—Initiator of Crankshaft Moving.
KEC—Kinetic Energy Controller, to compensate a difference between Expansion Energy and Compression Energy (see EE, CE), so that at end of the thermodynamic cycle, kinetic energy of the MP will be approximately the same as at begin of this cycle, using for this compensation the ES, ER and feedback from RSS.
LPLV—Low Pressure Liquid Volume.
LPC (40)—Low Pressure Chamber.
LPCIP—Input Part of the LPC.
LPCOP—Output Part of the LPC.
MP—Moving Parts: piston and other parts, connected to it.
NHM—Near Heater Means (in Sun power plant);
RM—Remote Means (in Sun power plant);
RSS (31)—Rotating position and Speed Sensor, to measure a rotating angle and speed of the crankshaft and so position and speed of piston.
TSBC (45)—Temperature Sensor, arranged to measure the Tbc.
TSBE (55)—Temperature Sensor to measure Tbe.
TSHT (42)—Temperature Sensor, arranged to measure the HT.
TSSH (48)—Temperature Sensor at output of Sun Heater. It measure temperature T48.
WCC (35)—Working Chamber for Compression, see ECM.
WCE (34)—Working Chamber for Expansion, see ECM.
WC—Working Chamber, that may include separated parts WCE and WCC or arranged as a single chamber for both functions, see ECM.
WF—Working Fluid.
WCLPOM (21)—Low Pressure Output Mean of the WC.
WCLPIM (20)—Low Pressure Input Mean of the WC.
WCHPCO (18)—Working Chamber High Pressure Controllable Opening, arranged to control possibility to displace at least a part of the WF between the WC and HPC.
WCHPIM (41)—High Pressure Input Mean of the WC.
WCHPCIMDPS (28)—Sensor to measure Differential Pressure between WC and HPCIM.
WCHPCOMDPS (43)—Sensor to measure Differential Pressure between WC and HPCOM (44).
WCLPCDPS (33)—Sensor to measure Differential Pressure between WC and LPC.
Zmachine—see ECM. Summed work of Zmachine during thermodynamic cycle may be near zero. In engine, Zmachine generate a compressed gas that used in expander to produce mechanical work. In heat pump, Zmachine generate a cool gas.

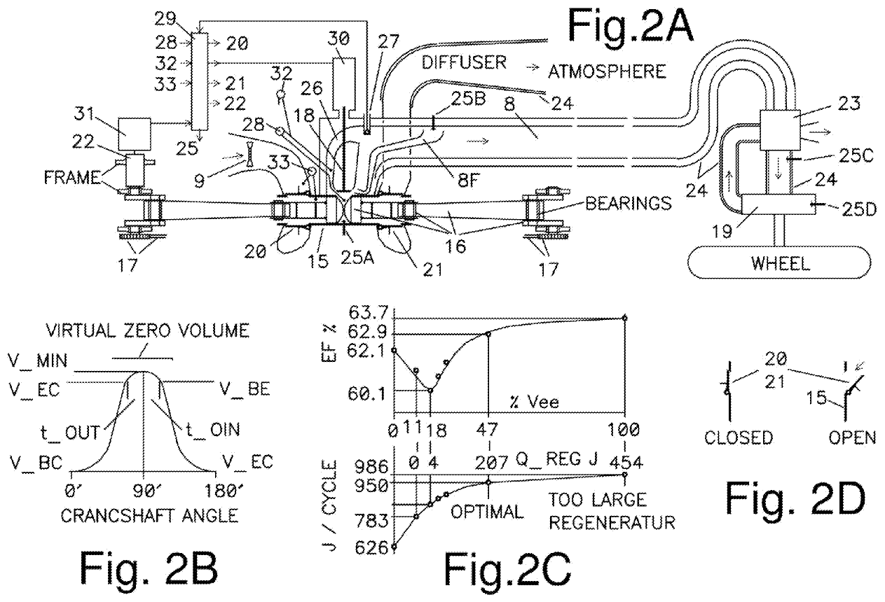

Parameters of Heat Machines
ABC—Acceleration Between Cycles, according to difference between kinetic energy of Moving Parts (MP) at begin and at end of the thermodynamic cycle.
CE—Energy for Compression of the Working Fluid (WF) in the Working Chamber (WC).
d (any parameter)—delta, a small changing of any parameter, for example dHP.
EE—Energy from Expansion of the WF in the WC.
HP or PH—High Pressure, there most cases it is pressure at end compression (Pec), but sometimes due to combustion, HP>Pec.
HT or TH—High Temperature, measured by sensor TSHT (42).
LP or PL—Low Pressure, most cases it is pressure at begin compression.
LT or TL—Low Temperature.
MW—Mechanical Work.
M—reciprocating mass of assembling 16.
mR—Rotating mass on radius R, this mass equivalent to sunmed inertial moment.
OE—Over Energy, energy of buffer 51 minus compression energy, see explain to FIG. 2, “Acceleration of crankshaft”.
TE—Thermal Energy.
Tbc—Temperature of the WF in the WC at Begin Compression.
Pbc—Pressure of the WF in the WC at Begin Compression.
Tec, Pec—Temperature, Pressure of the WF in the WC at End Compression.
T27—Temperature in HPCIM 26; T27 measured by HPCIMTS 27; for engine, T27>=Tec.
T48—Temperature after Sun heater 8SH, measured by sensor 48.
Tbe, Pbe—Temperature and Pressure of the WF in the WC at Begin Expansion.
Tmax—Maximum temperature of the WF in the WC, caused by combustion.
Tee—Temperature of the WF in the WC at End Expansion.
Pee—Pressure of the WF in the WC at End Expansion.
Tcvol—Temperature of a Cooling Volume. Tcvol is used for heat pump.
Thvol—Temperature of a Heating Volume. Thvol is used for heat pump.
TimeP—Time of Pause, while piston is fixated in a dead point.
TimeBH—time point when Begin Heating,
TimeEH—time point when End Heating inside the WC.
TimeOH—Over Heating Time, only for the ICE.
Vbc—Volume of the WF in the WC at Begin Compression.
Vec—Volume of the WF in the WC at End Compression.
Vbe—Volume of the WF in the WC at Begin Expansion.
Vee—Volume of the WF in the WC at End Expansion.
Veex—Volume of external expander at end expansion.
Vwc—Volume of the WC.
Vmax—a Maximum Volume of the WC; Vmax>=Vee, Vmax>=Vbc.
Vmin—a Minimum Volume of the WC; Vmin<=Vwc<=Vmax.
VCR—Volumetric Compression Ratio, defined as VCR=Vbc/Vec>1.
VER—Volumetric Expansion Ratio, defined as VER=Vee/Vbe>1.
Wr—rotation speed.
workv—virtual work. This work named “virtual”, so as it may be used, for example, by turbine, with expansion from Pee to 1 atmosphere. Often it is not used even in prior art, where workv is large. There, workv is small and used for inertial scavenging.
Zwork—algebraic sum of compression and expansion work in the ECM. It is summed work of Zmachine (see above ECM, Zmachine).

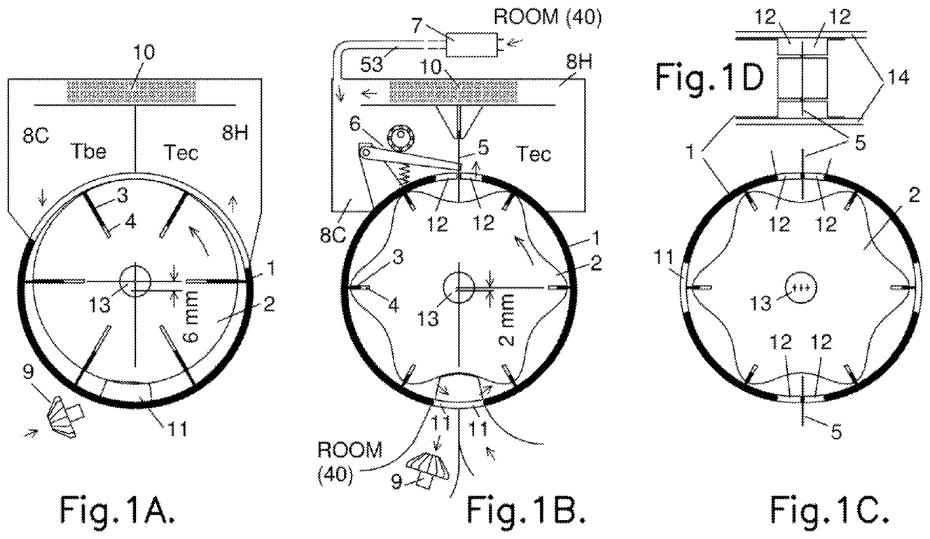

NUMBERS OF PARTS FOR ALL DRAWINGS
1. Body with non-limited length.
2. Rotor with specific shape.
3. Vanes.
4. Slots, sizes according to the vane.
5. Separator.
6. Driver for the separator.
7. Compressor.
8. High Pressure Chamber (HPC), include function of pressure buffer volume (it is not buffer
51), heating or cooling.
8B—HPC, thermal isolated buffer volume.
8C—HPC, cool part.
8F—Tubes with combustion product inside HPC.
80P—HPCOP—HPC Output Part.
8H—HPC, hot part.
8SH—Sun Heater (a part of the HPC).
8R—HPC with function of regenerator.
9. Blower.
10. Heat exchanger, counter flow type.
11. LP scavenging window.
12. Separated HP scavenging window.
13. Main shaft. In the prior art, FIG. 1A, main shaft get all power. In the invention, FIG. 1B, FIG. 1C, the main shaft gets a small part of power, which needs to compensate friction and vortex loss.
14. Side wall (left or right).
15. Cylinder.
16. Piston and crankshaft assembling with buffer 51, piston, beam, two crankshafts and connecting rods, roller bearings.
16S—Piston and crankshaft assembling, no buffer, separated pistons for compressor and expander.
16P—Piston and crankshaft assembling with buffer 51 and hydraulic pump.
16GP—Hydraulic pump.
16V—Input Valve of Hydraulic pump.
16O—Output valve of Hydraulic pump.
17. Synchronization belt and gears, no load and small mass.
17G. Synchronization gears, no belt.
18. WCHPCO, Working Chamber High Pressure Controllable Opening.
19. Remote Expander, power output.
20. WCLPIM, Working Chamber Low Pressure Input Mean.
21. WCLPOM, Working Chamber Low Pressure Output Mean.
22. Electrical machine, a small power, may include functions of Energy Receiver (ER), Energy Source (ES), Fixation of Crankshaft (FC), Initiation of Crankshaft Moving (ICM).
23. Regenerator, counter flow type, prefer with laminar current in micro channels.
24. Thermal isolated tubes.
25. Fuel Injector; design of injectors 25A-25D may be according to working place.
26. HPCIM, HPC Input Mean, include a channel arranged with gradual increasing a transverse section from the WCHPCO 18 to HPC 8, and for the heat engine have a thermal isolation.
27. HPCIMTS, temperature sensor, for example a thermo-coupler, arranged to measure temperature T27 of the WF in HPCIM 26.
28. WCHPCIMDPS, sensor to measure a differential pressure between WC (Cylinder) 15 and
HPCIM 26. It may be a mechanical mean, arranged to open WCHPCO 18 when the differential pressure is near zero, but prefer a sensor, matched to electrical controller.
29. Electrical controller. Includes electrical accumulator and Kinetic Energy Controller (KEC) and arranged for functions according to input and output signals signed on drawings.
30. Valve driver, that may include mechanical oscillator, fixated at 2 points by electrical magnets.
31. RSS, Rotating Speed and position Sensor.
32. HPCPS, pressure sensor in HPC (between HPC and Atmosphere).
33. WCLPCDPS, differential pressure sensor between WC 15 and LPC 40.
34. WCE expander.
35. WCC compressor.
36. Valve LP_out.
37. Valve HP_in.
38. Valve LP_in.
39. Valve HP_out.
40. LPC—Low Pressure Chamber, or Atmosphere.
40R. LPC part of regenerator (output connected to atmosphere).
41. WCHPIM, High Pressure Input Mean of the WC.
42. TSHT—Temperature Sensor, arranged to measure the HT.
43. WCHPCOMDPS—Sensor to measure Differential Pressure between WC and HPCOM 44.
44. HPCOM—HPC Output Mean for the WF to WC, that include a channel between the HPC and the WCHPIM (41), this channel arranged with gradual decreasing a transverse section from the HPC to WCHPIM, whereby to diminish loss of kinetic energy of the WF, and in the heat engine, the HPCOM is thermal isolated.
45. TSBC—Temperature Sensor, arranged to measure the Tbc.
46. Electrical Generator.
47. HPSDV—Single Direction Valve, that make possible current inside the HPC from the HPCIP to HPCO.
48. TSSH—Temperature Sensor at output of Sun Heater 8SH. It measure temperature T48.
49. Wind turbine.
50. Distributor.
51. Buffer.
52. Valve with sections 52cIR, 52cOR, 52cEA, 52HER, 52HIA, 52HOA.
53. Cooling tube.
54. On/off valve.
55. TSbe—Temperature Sensor to measure Tbe.
56. HPCBPS—HPC buffer volume (it is not buffer 51) pressure sensor.
58. TSILPC—Temperature sensor at Input of LPC.

Parameters are examples by computer simulations. Parts according to NUMBERS OF PARTS FOR ALL DRAWINGS.

With reference to FIG. 1B, there is shown the PDHMR in accordance with the present invention, the embodiment is heat pump for home conditioner or refrigerator. FIG. 1A is a simplified view on the prior art for it, according to [7] WO1998057038 A1. FIG. 1C is a version with no circular symmetrical body, so the rotor no load from pressure force. FIG. 1D is a view on body. FIG. 1(A-D) include parts:
1. Body with no-limited length (for the prior art, FIG. 1A, the length is limited, see explain below).
2. Rotor with specific (see explain below) shape.
3. Vanes (for the prior art, vanes have sufficiency more radial length).
4. Slots, sizes according to the vane.
5. Separator (no exist in the prior art).
6. Driver for the separator.
7. Compressor (no exist in the prior art).
8. High Pressure Chamber (HPC). 8C—cool part, 8H—hot part.
9. Blower.
10. Heat exchanger, counter flow type, cooling water inside tubes.
11. LP scavenging window. In the invention, a large window along the length of body L, separated to input and output part. In the prior art, a small input and output windows in a side walls.
12. Separated HP scavenging window (no exist in the prior art).
13. Main shaft. In the prior art, FIG. 1A, main shaft get all power. In the invention, FIG. 1B, FIG. 1C, the main shaft gets a small part of power that need to compensate friction and vortex loss, and main power source connected to compressor 7. Power sources are not on drawings.
14. Side wall (left or right).

The counter flow heat exchanger 10 transferring heat from air with parameters Pec, Tec to water, that is with atmospheric pressure (0.1 MPa) inside tubes. Hot water may be used, or cooled by atmospheric air in external heat exchanger. Every WC formed by surfaces of neighboring vanes 3, parts of surfaces of the side walls 14, a part of surface of the body 1, and a part of surface of the rotor 2. During rotation of the rotor 2, volume (Vwc) of every WC is changing between Vmin and Vmax, kv=<Vmax/Vmin. A space, where the Vwc is diminished to Vmin, named a High Pressure Space (HPS); a space, where the Vwc is increased to theVmax, named a Low Pressure Space (LPS). Prefer a small as possible gap between tip of separator 5 and rotor 2. For example, if swing of oscillation of Separator 5 is 15 mm, may be: 0<gap<0.3 mm, even larger gap is not critical. Synchronization gear between rotor 2 and driver 6 is not shown. Shape of rotor 2 is according to oscillation of separator 5 and caused by design of driver 6.

WORKING CYCLE include scavenging by blower 9 at LPS, so output cool air with parameters LP=Pee, Tee, is displacing by room air with Pbc=LP, Tbc. During moving WC from LPS to HPS, take place compression to HP=Pec, Tec. Then scavenging in HPS between the WC and HPC 8, so air with Pec, Tec, is displacing by air with Pbe=HP, Tbe. During moving WC from HPS to LPS, take place expansion to Pee, Tee. Length of scavenging windows 11, 12 is according to length L of body 1, so L may be large (see example below). In the prior art, all windows are inside side walls, so L limited by speed of air during scavenging.

So, the main principle is: displacing the WF between WC(HPS) and HPC 8, with very small changing volume of the WC.

Scavenging across WC by a blower (Separator 5); the blower is based on the positive displacement principle.

Below Example According Computer Calculations for this Home Conditioner.

Rotation speed Wr=63 rad/s, length of body L=1 m (this large L is practically impossible for the prior art), internal radius of body 1, Rb=72 mm, throughput V=0.045 m³/s, kv=1.358, kp=1.535, kt=1.13; Pbc=0.1 MPa, Pec=0.1535 MPa, Tbc=300° K, Tec=339° K, Tbe=308⁰K=35° C., Tee=273° K=0° C. COP=Tee/(Tbe-Tee)=7.8 (if no loss). Density of Air at 0° C. is 1.27 kg/m³. Power: Pcool=(Tbc-Tee)° K.*1000 J/kg/° K.*1.27 kg/m³*0.045 m³/s=1549 W; mechanical power: Pmech=Pcool/COP=199 W, it is power that need for Air compressor 7 if no loss. In assembling, that include body 1, rotor 2 and vanes 3, compression and expansion energy are the same (EC−EE=Zero); if no loss, it no send and no get mechanical energy and so named Zmachine (see GLOSSARY . . . ). It get from a room V=0.045 m³/s with Tbc (see above WORKING CYCLE) and send to the room the same V, but with Tee. To keep BALANCE OF AIR MASSE, throughput from air compressor 7 is: V7=V*Tbc/Tee−V=0.00945 m³/s. May to place it out of the room, and connect input to external air. If dT between external hot air and the room air is 5° K, ventilation by V7 add to the room heat power 54 W.

Example for Cooling Power for a Room 20 m²:

Thermal transfer coefficient x=8 W/M²/° K; surface for thermal transfer S=90 m²; mean dT between room air and walls 2.5° K; cooling power=8*90*2.5=1800 W. Calculated above Pcool=1549 W is for Wr=63 rad/s. May increase Wr to 16% and get Pcool=1800 W.

Below are Calculations for Loss (“A”−“G”), in “G”, Calculated that Increasing Wr to 16% May Diminish COP to 2%.

A. For compressor 7, with output power 199 W, suppose loss7=20 W.

B. If air speed during scavenging is 9 m/s (twice more than linear speed of rotor 2), and volume V=0.045 m³/s loss all kinetic energy 4 times during cycle, vortex loss is: loss V=9 W.

C. Sizes of Capron vane 3 is (1*8*1000) mm³. For 6 vanes and Wr=63 rad/s, inertial force on surface of body 1, is: Pw=16N. If friction coefficient kfr=0.2, sliding of vanes along surface of body 1 cause loss Pw=14.5 Watt.

D. Pressure in slot 4 is maximum between pressures from a left and right sides of vane 3, and it is Pec. According to computer simulation, mean difference of pressures that press vane to body, is: dp12 m=0.33*(Pec-Pbc)=1.8N/cm². Suppose that dp12 m placed on ½ from vane width, so on 0.5 mm, and pressure forces on the rest part are compensated. So mean radial pressure force from all vanes is 54 N, and for mentioned kfr and Wr, it cause loss Pfr=49 W.

E_. Load from pressure force (for version at FIG. 1C, this load no exist), on two rolling bearings, supporting rotor 2, is 3600 N. With roller friction coefficient 0.001 and diameter of main shaft 13 is 20 mm, power loss: Pbearing=2.3 Watt.

F. Pressure force PN, normal to side surface of vane 3, cause friction force X, directed along radius. When vane 3 is moving from slot 4, force SF, pressing vane 3 to body 1, is: SF=PI−X, where PI is sum of pressure and inertial forces along radius. Must PI>X, else vane 3 cannot move from slot 4. When vane 3 is moving to slot 4, SF=PI+X. So, mean SF=PI, and force X cannot cause addition loss caused by sliding vane 3 along body 1. But, friction between vane 3 and surface of slot 4 cause loss: lossX=PN*FRN*S*Wr/6.3, where S is sliding distance, for this example S=8 mm per revolution; FRN is friction coefficient, suppose it is 0.1. So, loss caused by friction between slots and vanes: lossX=3.6 W.

G. With loss, mechanical power (see A-F) is: 199+20+9+14.5+49+2.3+3.6=297 Watt; COP_real=1549/297=5.22.

It is true for car conditioner, connected directly to engine. If compressor 7 work from electrical motor, and addition motor is connected to Zmachine to compensate loss, both motors with efficiency 0.9, COPe=5.22*0.9=4.69. For car, electrical energy produced by generator with efficiency 0.9 (the best case), so COPee=4.69*0.9=4.22. Separated HP scavenging window 12 (FIG. 1B) may be not symmetrical, so possible to compensate any part of calculated loss 297 W by addition power from compressor 7. For this case power of mentioned addition motor may be very small.

If increase Wr to 16%, Pcool*1.16=1800 W (see Example for cooling power for a room 20 m²), but loss increase.

Are loss, proportional to Wr² or to Wr³. So, 1.16²=1.35, and 1.16³=1.56. For this case, mechanical power for Wr*1.16, is:

199*1.16+20*1.16+9*1.35+14.5*1.56+49*1.16+2.3*1.16+3.6*1.16=353;

COPw=1800/353=5.1. So, when Wr increased to 16%, COP diminished to 2%, that mostly caused by loss from inertial force, proportional to Wr³. With reference to FIG. 1C, there is shown version with no-circular body 1, this version is important for large power machine. With long, but symmetrical plastic rotor, no deformation and no load on bearings (see “E”, 3600 N). In this version, no load on vane 3 during moving across a scavenging zone (see below).

With reference to FIG. 1D, there is shown view on body 1, with large window 12 for scavenging between the WC and HPC. When vane 3 is moving across a scavenging zone (LP window 11 or HP window 12), vane 3 is supported by at least two small parts of body 1. These parts seems as “bridges”, with small gap according to width of separator 5 that not get load from pressure and may be, for example, 0.2 mm, sufficiency smaller, then width of vane 3.

### Comparing with Prior Art

For the prior art (FIG. 1A), radial length of vane 3 must be 24 mm, 3 times more, then for this invention (FIG. 1B), and width is 3 times more, to stand against pressure force. This advantage of the invention caused by scavenging in HPS. According to calculations C, D, loss from inertial force in prior art may be 14.5*9=131 W, and so as width is 3 times more, loss from radial pressure force may be 49*3=147 W, at all 131+147=278 W. For invention, 14.5+49=64 W. But, in the prior art, vanes 3 are not sliding along surface of body 1; they supported by rotation ring (no on FIG. 1A). Sliding distance of vanes along this ring is small and caused by distance between centers of rotor 2 and body 1, so loss caused by this sliding is small. But, the rotating ring get pressure force 3600 N (see “E”), that cause addition loss. In the invention, a large sliding speed and a small load may cause useful effect of “gas bearing” between vanes 3 and body 1, this case Pw+Pfr<<64 W. It seems, in the prior art Pw+Pfr is not sufficiency smaller, then in invention. Problems caused by this ring explained below.

According to “F”, lossX=3.6 W, but for the prior art, 3.6*3*3=32 W, so as 3 times more PN and 3 times more S. Note, that lossX calculated for friction coefficient FRN=0.1. Larger FRN is problematic for the prior art.

The rotating ring restrict version with no-load rotor 2, that is important for large power, see above explain to FIG. 1C.

The rotating ring restrict possibility for current of gas across windows in body 1, and are possible only windows in side walls 14. So length of body is very small (or must small Wr), else vortex loss is too large.

Without the rotating ring, the prior art practically cannot work so as large friction loss. With the rotating ring, must be only a small length of body or small Wr.

To keep BALANCE OF AIR MASSE (see above), relation between volumes of hot and cool gas must be according to Tbc/Tee, but Tbc and Tee are not constant. In the prior art, this relation caused by “hard” design, that cause loss of COP and sound noise if Tbc/Tee is not optimal. In the invention, this problem is solved by regulation of compressor 7. Another advantage of invention is that compressor 7 is small (V7=0.00945 m³/s). Zmachine with V=0.045 m³/s is placed in the cooling room, but compressor 7, that get main power, may be directly connected to engine of car, to wind turbine, etc.,

and placed out of room—see above example with “recommended ventilation rate . . . .”

With reference to FIG. 2A, there is shown the Internal Combustion Engine (ICE) in accordance with present invention. The ICE is 2 strokes, 2 opposite pistons in the same cylinder (WC), with at least a single remote expander.

In the cylinder take place a thermodynamic cycle with summed compression and expansion work may be near zero (Zwork=0, see GLOSSARY . . . ), so it is Zmachine that generates compressed gas to make mechanical work by the expander. Displacing a part of the WF from the WC to HPC due to diminishing volume of the WC and due to combustion in it, with Pulse Pause Modulation (PPM) in Zmachine. Due to PPM, time for combustion is optimal and not caused by mean rotation speed, so, efficiency of the engine and quality of combustion is maximal for every working mode. Engine of a car most time is working at a partly load, and for prior art, mean efficiency may be twice smaller than optimal. Remote expanders may be connected directly to wheels. Due to PPM, throughput of Zmachine is according to demand of the expanders. For maximum power, it is possible combustion in HPC and in expanders.

The embodiment at FIG. 2A comprising parts 8, 8F, 9, 15-24, 25(A-D)-33 with names according to NUMBERS OF PARTS FOR ALL DRAWINGS section.

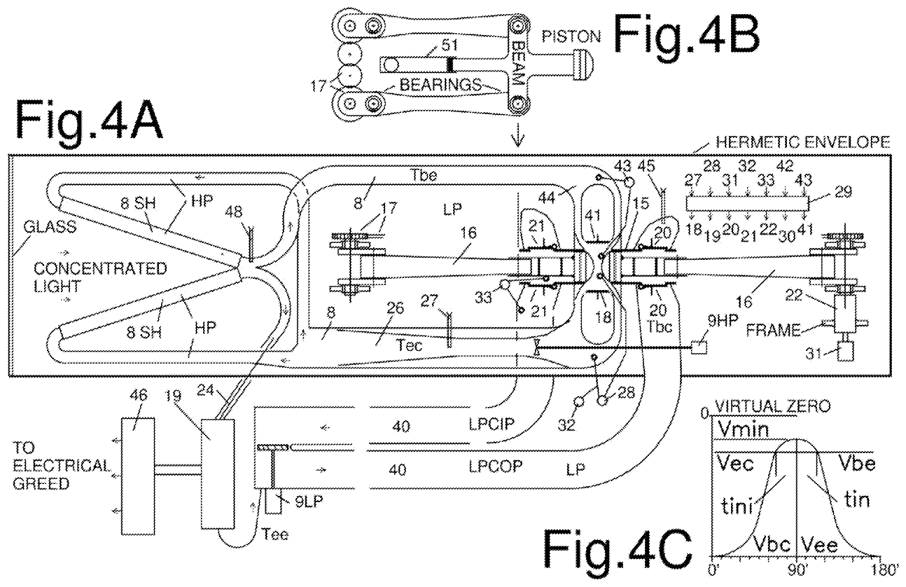

Assembling 16 include the piston, beam, buffer 51, connecting rods, crankshafts, bearings, and synchronization gears 17 with belt. All these parts are referenced as 16, see in addition FIG. 4B. Buffer 51 filled with compressed gas and may be connected to HPC 8 with long and small diameter tube (no shown). Crankshaft 16 may no transfer power if Zwork is near zero, and it is the preferred working mode, so crankshaft 16 has a small mass, that with using PPM, cause a small gas load on roller bearings (see below EXPLAIN FOR PPM . . . ). Expander 19 is power output of the engine, connected to HPC 8 with thermal isolated tubes 24 across optional counter flow regenerator 23. Output gas from cylinder 15 with temperature Tee may go to appropriate part of regenerator 23 if Tee is more then temperature in this part, whereby transfer heat to input of expander 19. Below supposed, that mentioned gas with Tee goes to atmosphere or to heater of any EHE. Electrical machine 22 and position sensor 31 connected to one of crankshafts 16 for fine PPM regulation by electrical controller 29.

Working cycle include scavenging in cylinder 15 by blower 9 across at least a single valve WCLPIM 20 and WCLPOM 21, but prefer using several valves to diminish vortex and thermal loss; in addition, for this purposes, head of piston 16 have a streamlined shape. Below see more after “scavenging.” After end compression in cylinder 15, begin opening WCHPCO 18, and compressed air, during output time Tout (FIG. 2B), is pushing to HPC 8. Kinetic energy of current across WCLPOM 21 is partly restoring inside HPCIM 26 (see ABBREVATIONS).

Opening WCHPCO 18 begin by driver 30 when differential pressure dPx from sensor 28 is near zero. Appropriate value dPx is defining with controller 29 by feedback to avoid a fast jump of dPx. Inside interval Tout (FIG. 2B), take place fuel injection to cylinder 15 by Injector 25A, placed far from WCHPCO 18. Combustion in this “heating part” cause pushing “removing part” of the WF, that is near WCHPCO 18, to HPC 8 in addition to pushing by piston 16; so, moving of piston 16 under HP is small. The “removing part”, and so air in HPC 8, includes a small (prefer zero) quantity of fuel that will be combusted in HPC 8. So temperature T27 in HPCIM 26 may be more then Tec; T27 measured by sensor HPCIMTS 27, about T27 see below. HPC 8 is thermal isolated (see thermal isolated tubes 24) and to diminish thermal transfer caused by vortex, HPCIM 26 have streamline shape. May increase power by injectin fuel to HPC 8 with Injector 25B. If work regenerator 23, instead Injector 25B may use Injector 25C, placed after regenerator 23. Any case may use Injector 25D inside expander 19, that may be arranged for controlled combustion, for example with approximately constant temperature during at least a part of expansion. After output from expander 19, a part of heat returned in regenerator 23, and so temperature at input of expander is more than Tec, but limited by properties of material; this case, expander 19 is not cooled and so no heat loss in it. Any case T27 sufficiency smaller than maximum temperature Tmax in cylinder 15, that may be 2000° K, as in prior art ICE. If WCHPCO 18 not closed when volume of cylinder 15 begin increase, during Output/Input Time (Toin at FIG. 2B), direction of current across WCHPCO 18 is according to power of combustion.

After closing WCHPCO 18 and end combustion, begin expansion, at this point volume of cylinder 15 is Vbe. If Vec=Vbe, and no combustion during expansion, and no loss, summed work of cycle is zero (Zwork=0), and all output work is from expander 19.

Possible mode “d”, with end combustion after closing WCHPCO 18, or mode “e”, with Vbe>Vec, or mode “f” with combination “d” and “e”, this causes Zwork>0 and may be Pec>LP. According to parameters in “Explain to Table_Z1” (see below), may calculate, that if dP=Pee−LP=0.01 MPa, it cause loss 0.4 J, while useful work is at least 635 J.

A small Zwork may compensate friction loss, may be used by electrical machine 22 and stored in electrical accumulator (no shown). According to working mode of electrical machine 22, mean speed of crankshaft 16 may be changed. At end expansion in cylinder 15, must open valves 21, then 20. As mentioned, scavenging may be initiated by blower 9. During scavenging, piston 16 may stay any controlled time (see below EXPLAIN FOR PPM), that cause a good scavenging with a small power of blower 9. If Pee>LP, may use ISC (see GLOSSARY . . . ). To begin scavenging, at end expansion stroke, with using signal from Rotating Speed and position Sensor (RSS) 31, controller 29 with one of drivers 30 (not shown) open valve 21. Due to long tube with diffuser, energy of over pressure (Pee>LP), is converted to kinetic energy of moving gas. When according to signal from sensor 33, pressure in cylinder 15 is near Atmospheric pressure, another driver 30 (not shown) open valve 20 and take place ISC. For mentioned parameters in “Explain to Table_Z1”, dP=0.01 MPa cause beginning scavenging speed: (2*dP/density)^{0.5}=200 m/s, that is good to initiate ISC even for maximum power.

Version “g”:

Selecting the Volumetric Compression Ratio (VCR) such that Pec<HP, then performing combustion in approximately constant volume Vec, and when the pressure in the WC increases to HP or exceeds HP, according to the dPx, opening WCHPCO 18. A small part of fuel, prefer Hydrogen, injected before end compression, and combustion may be initiated by spark (a sparker and injector not shown). Version “g” cause preheating for good and fast combustion of fuel from Injector 25A. For minimum power, used only Injector 25A.

Displacing the “Removing Part” May be, for Example, According to the Following Several Versions:

Version a.

Selecting the Vec to be approximately equivalent to Vmin, and displacing the “removing part” mostly by heat expansion of the “heating part”, whereby will be near zero moving of piston 16 under pressure HP, and so minimum friction loss. Version ‘a’ cause partly mixing between the “heating” and “removing” parts, so T27>Tec. Vmin is a construction parameter. Vec is according to begin opening WCHPCO 18 that cause regulation of VCR. Volumetric Expansion Ratio (VER) in cylinder 15, caused by Vbe, that is according to end closing WCHPCO 18 if then there is no combustion. If after closing WCHPCO 18 there no combustion, preferably Vbe will be slightly above Vec (Vbe>=Vec for example, Vbe=1.1*Vec).

Version b.

Selecting Vec>Vmin, and displacing the WF mostly by moving piston 16, performing combustion mostly when WCHPCO 18 is closed, so T27 is near Tec=Tbc*VCR^{(ka-1)}, ka=1.4. T27=Tec cause the best using of regenerator 23, minimum heat loss in HPC 8 and the widest regulation of cycle power: minimum power with temperature Tec inside HPC 8, and maximum power with using Injectors 25(B, C, D), as explained above. Version b cause more friction loss, than Version a.

Version c.

Compromises between Versions “a” and “b”, with Vec>Vmin and begin combustion before closing WCHPCO 18.

Version h.

Combination of the following three processes:
After ending compression, opening WCHPCO 18 and by diminishing Vwc to Vmin, displacing a part of the WF (air) to HPC 8.
Additional displacing WF to HPC 8 with combustion inside Cylinder 15, caused by Injector 25A.
During increasing Vwc from Vmin to Vbe, displacing combustion product from tube 8F to Cylinder 15. For this purpose, using the inertial property of the gas flowed from WCHPCO 18. Due to the high speed of this flow, the WF cannot return to Cylinder 15, and without mixing with the combustion product that has been partly directed to cylinder 15 from at least single Tube 8F. This product is created by combustion in Tube 8F due to Injector 25B. Due to appropriate volume of Tube 8F, combustion in Tube 8F has been finished before input to Cylinder 15. After closing WCHPCO 18, expansion of combustion product inside Cylinder 15 begins. So, only a part of exhaust from Cylinder 15 caused by combustion during a short time.

### Explain to Table_Z1

So as Table_Z1 used only to compare parameters, supposed, that no loss of heat to walls of WC and expander. If calculate this loss according to empiric formula for ICE (from many versions, selected not too optimistic and not too pessimistic), efficiency (Ef) diminish to (1.5-2.5)%. Comparing to prior art ICE, this small drop of Ef caused by mentioned smaller time for heat transfer, smaller temperature of gas, larger temperature of walls and using 2 pistons in the same cylinder—see SUMMARY OF THE INVENTION . . . This empiric formula is for large vortex, that need for better combustion, but increase thermal loss, while in this invention, vortex is smaller and so smaller thermal loss. The formula is: X=(1+1.24*pvm)*(T*P²*10⁻¹⁰)^{0.33}, where X—thermal transfer coefficient, pvm—piston mean velocity.

In Table_Z1, “Ef” includes viscosity loss in regenerator, vortex and friction loss. For example, in string 6, Ef=63.0%, but without this loss, Ef=63.5%; this small distinction due to roller bearings (that is problematic for prior art, see below Regulation near HPDP) and a small moving of piston under maximum P (large moving in prior art, up to Virtual zero Volume, FIG. 2B).

Working mode is according “Version c” (see above). Zwork=0, adiabatic expansion in WC (cylinder 15), partly isothermal expansion in expander 19. kv=12, kt=2.7, Pbc=0.1 MPa, Pec=3.24 MPa, Tbc=300° K, Tec=806° K, Vbc=Vee=1090 cm³, Vec=Vbe=91 cm³, Vmin=45 cm³, Tmax=1700° K, Tee=634° K. During closing WCHPCO 18, near Vmin, begin combustion in WC with using Injector 25A. Supposed combustion with constant P=Pec, with expansion to Vbe due to appropriate work of Injector 25A. WCHPCO 18 may be open during this combustion and mistakes compensated by any small current of WF across WCHPCO 18. End combustion and closing WCHPCO 18 at Vbe=Vec, Tmax, so P=Pee=Pbc, Zwork=0. Mass of input air (in Vbc) is 1.32 g, from it 0.63 g with Pec, Tec is sent to HPC 8. Inside HPC 8, THPC=1500° K>Tec, so as before input to expander 19, take place heating in regenerator 23 (between hot and cool gas, dTr=14° K) and then combustion using Injector 25C (this combustion no need if minimum power, but Table_Z1 calculated for maximum power).

Compression energy CE=1/(ka−1)*(Pbc*Vbc−Pec*Vec)−Pbc*(Vec−Vbc)=367 J. Addition 140 J caused by output a part of compressed air dV=Vec−Vmin=46 cm³ to HPC 8, the same dV and 140 J returned by heat expansion during mentioned combustion from Injector 25A. Pair of buffers 51 must supply 367+140=507 J. Moving piston cause addition friction loss according dV=46 cm³. For “Version a” (above), dV=0. In prior art, piston push all volume Vec=91 cm³.

In Table_Z1 named: Qreg—heat, transferred in regenerator 23; Veex—part of volume of expander 19 with isothermal expansion, begin combustion after end input from HPC; J/cycle—work in cycle; Ef—efficiency.

TABLE_Z1
Engine with partly isothermal expander

| Qreg, J | Veex, % | J/cycle | Ef, % | string |
|---|---|---|---|---|
| 0 | 0 | 635 | 62 | 1 |
| 0 | 11 | 799 | 60.9 | 2 |
| 4 | 18 | 858 | 60.4 | 3 |
| 39 | 22 | 878 | 60.9 | 4 |
| 75 | 26 | 901 | 61.5 | 5 |
| 219 | 47 | 964 | 63 | 6 |
| 454 | 96 | 997 | 63.7* | 7 |

*Examples for dTr and gas friction loss QrL in regenerator: dTr = 14° C., QrL = 4 J, Ef = 63.7%; dTr = 24° K, QrL = 2 J, Ef = 63.5%; dTr = 5° K, QrL = 11 J, Ef = 63.5%. So, dTr = 14° K seems the best (Ef = 63.7%), but prefer dTr = 24° K, so as near the same efficiency may get with twice smaller regenerator and so lower cost and weight.

From Table_Z1 may see that for engine without regenerator, a good efficiency, but a small power (J/cycle), may get with adiabatic expansion in expander (string 1). The same engine with partly isothermal expansion have a smaller efficiency, but power increase (string 3 is local minimum of efficiency, when regenerator only begin to work).

The best mode seems at string 7, but even a mean size regenerator with optimal dTr improve parameters of engine (string 6) and this case seems as optimal, see FIG. 2C. If use output gas of this engine with temperature Tee+dTr>806° K as heat source for EHE (FIG. 4), that give Ef=42% for HT=750⁰K, the integrated design may give efficiency approximately: Ef=60+(100−60)*0.42=77% (after thermal loss). Note, that for Carnot cycle, Ef_Carnot=(1700−300)/1700=82%.

### There are Mentioned Injectors 25 (A-D) on FIG. 2A

A. Prefer using a “good” fuel, so as a short time for combustion in cylinder 15. At a full power mode, using<30% from fuel inside cylinder 15. Prefer using CH4 or H2.

B. Option if no used regenerator 23. So as a large time for combustion in the HPC, may use a “bad” fuel.

C. Option for over-heating after regenerator 23, or addition heating before expander 19 to avoid thermal loss in a long tube 8. A mean time for combustion, but a large temperature before combustion, so may use a “bad” fuel.

D. Heating in expander 19 if used regenerator 23. If no regenerator, Injector 25D is option for a pic power. Time for combustion in expander 19 is according to working mode.

If expander 19 directly connected to a wheel, for the wheel D=50 cm and velocity 120 km/h, need 1270 rev/min that is not a large speed for combustion.

Combustion in expander 19 begin at a temperature T4>Tec (if used regenerator or Injector 25B or 25C), that help for combustion. Output gas from expander 19 goes across regenerator 23, so is a large time to end combustion.

So, in the expander 19 no must be used a “good” fuel.

### Explain for PPM (Pulse Pause Modulation)

Free piston engine (prior art 8, 9) may work with PPM, when piston is fixated at Low Pressure Dead Point (LPDP). Advantage of PPM is wide regulation time for scavenging at LPDP with optimal compression, combustion and expansion time. No crankshaft; output energy used by hydraulic plunger pump and stored in accumulator. For PPM in the prior art used controllable hydraulic valve, that cause large loss. Between other problems of free piston engines, is very small time for combustion.

In the invention, speed of crankshaft 16 near LPDP and HPDP have independent regulations by controller 29, including possibility to fixate crankshaft 16. So have advantages of prior art, but without problems of it. Time for combustion is regulated, PPM not cause addition loss, the crankshaft no transfer power, small masse, small load on bearings, so used roller bearings, may use plastic or Aluminum crankshaft.

Due to PPM, possible fine synchronization between working cycle of cylinder 15 and expander 19, for example with input stroke of expander 19 when WF is pushed from cylinder 15 to HPC 8. So, may be used a small volume HPC 8 without large changing of pressure HP_in it (this changing may cause loss efficiency).

### Regulation Near LPDP

For embodiment FIG. 2A, sum of compression and expansion works and work of buffer 51 (see FIG. 4B) near LPDP may be near zero; is it zero or not, this sum named Zwork. To regulate speed of crankshaft 16 near LPDP, used a course and a fine regulation. The course regulation caused by appropriate adjusting of combustion process with Injector 25A and with control of WCHPCO 18, whereby kinetic energy of assembling 16 when piston is near LPDP, is according to desired velocity of crankshaft or near zero, if need fixation in LPDP. Near LPDP, take place the fine regulation by controller 29 with using RSS 31 and Electrical Machine 22 that may send energy to electrical accumulator or get energy from it. If need fixation, kinetic energy at LPDP must be near zero and so crankshaft 16 is fixated by friction force of bearings, loaded by a force from buffer 51. So bearings include function of FC (Fixation of Crankshaft). If crankshaft 16 is not exactly at LPDP, moment of force from buffer 51 may be more than moment from the friction force, but Electrical Machine 22 may compensate this mistake, including function of FC. Controller 29 uses information from RSS 31.

Near LPDP, force caused by buffer 51 is sufficiency smaller than pressure force in HPDP. Prefer, that regulation of cycles per second or fixation of crankshaft 16 take place only at LPDP, and near HPDP a large pressure force partly compensated by inertial force for every working mode. For this purpose, energy from buffer 51 must be more, then Compression Energy CE, and this over energy transferred to kinetic energy near HPDP. So moving parts of assembling 16 include functions of ER and ES (see ABBREVIATIONS OF PARTS). This compensation is not possible in prior art.

### Acceleration of Crankshaft

When crankshaft 16 is fixed at any DP (Dead Point), roller bearings are under static load. When crankshaft 16 is moving, roller bearings are under dynamic load. For good lifetime, permissible dynamic load must be 5-20 times smaller, than static. During moving, inertial forces are against loads from gas forces or from buffer 51, so, dynamic load diminish. It is very useful effect. With smaller dynamic loads, not only roller friction diminish, but may use light roller bearings and so diminish slide friction between rollers and separator, caused by inertial forces from reciprocating moving. To increase mentioned useful effect, may increase masse of parts with reciprocating moving, but prefer diminish inertial moment of rotating parts. For electrical machine with magnetic rotor: Me=L*D*a; I=b*L*D⁴ so I=C*Me*D³, where Me is moment of magnetic force; L, D, I are length, diameter, inertial moment of rotor; C=b/a=constant. “I” may be very small (with the same Me) if diminish “D”. So, summed inertial moment is mostly caused by inertial moment of crankshaft 16. Main power output is from expander 19, crankshaft 16 no send power (except a small power to or from electrical machine 22). So, rotating moment, transferred by crankshaft 16, is very small. Crankshaft 16 from Aluminum or plastic may be fast accelerated near any DP by at least a single electrical machine 22. Prefer, that every side of every crankshaft is connected to electrical machine 22. Example below explains mentioned useful effect (partly compensation of gas force).

Suppose, that radius of crankshaft 16 is R=5 cm, Vbc=1090 cm³ (see Explain to Table_Z1). Used 2 pistons 16 in the same cylinder 15 (FIG. 2A), so surface of piston is: S=Vbc/2/2/R=54.5 cm²; for Pec=3.2 MPa, LP=0.1 MPa, gas force Fgas=S*(Pec−LP)=16895 N. So as pair buffers supply 507 J, a single buffer 51 send Eb=253.5 J, force from it: Fb=Eb/2/R=2535N, it is static force on bearings when fixation in LPDP. Maximum static load on bearings may be if fixation in HPDP: Fmax=Fgas−Fb=14360 N. Rotating mass on radius R, this mass equivalent to summed inertial moment of two crankshafts (FIG. 4B) is mR=0.3 kg, and reciprocating mass of assembling 16 is: M=5 kg (design on FIG. 2A is symmetrical and so balanced). When rotating angle is 90°, only mR/M=0.06 of gas force (that caused by Fb and by current P<Pec) is placed on crankshaft bearings when rotating angle is 90°. For prior art, mR>>M and all gas force is placed on bearings.

Prefer to avoid fixation near HPDP, so exist kinetic energy near HPDP (see above). To compensate Fmax=14360 N, acceleration A of reciprocating parts mast be: A=Fmax/M=2872 m/s². Rotation speed Wr is not constant. To get A, must Wr=(A/R)^{0.5}=240 rad/s=2290 rev/min. To get this Wr at HPDP, energy of buffer 51 (FIG. 4B) must be more than compression energy, this “Over Energy” OE is transferred to kinetic energy of rotating parts of assembling 16 near HPDP: OE=(Wr*R)²*mR/2=21.6 J. So, mentioned above energy Eb=253.5 J must increase to 21.6/253.5=8.5%. If buffer is connected to HPC (as mentioned, with “long and small diameter tube”), for this purpose may adjust HP. Prefer, that volume of buffer 51 is sufficiency more, than changing of it. For example, for buffer kv=1.1, kp=1.14, kt=1.04, so for T=300° K swing=12° K practically not cause loss of energy from thermal transfer between gas and body of the buffer.

As calculated, near HPDP, Wr=240 rad/sec. So as was fixation, Wr=0 at LPDP. What “Wr” is, for example, at angle 90° ? At this angle, near Eb/2=127 J is converted to any kinetic energy “C” and to energy of pressured gas. If was moving from LPDP, energy used for compression is small (most energy converted near HPDP). Suppose, that C=100 J, so, near angle 90°: Wr=(2*C/(mR+M)/R²)^{0.5}=124 rad/s=1185 rev/min. It is approximately maximum mean rotation speed if fixation near LPDP was “zero” time, or, without fixation, Wr at LPDP was very small. With mentioned parameters mR=0.3 kg and M=5 kg, cannot sufficiency increase “mean” speed, so as it cause too large inertial force at HPDP. Due to fixation at LPDP, regulation to low mean speed is unlimited, but Wr at HPDP is near mentioned optimal 240 rad/s. If M=1.25 kg, instead 240 rad/s get 480 rad/s with full compensation of gas force. To calculate minimum “M”, suppose, that used two Aluminum rods (FIG. 4B), length=3*R=15 cm. Due to compensation, the rod not get maximum load, but must calculate it for this case, so load=14360/2=7180 N/cm². For stress 10000 N/cm², masse of 2 rods is near 0.08 kg, bearings 0.08 kg; with piston beam suppose minimum M=0.3 kg. So maximum Wr is limited by combustion, and relatively small Wr near LPDP is good for scavenging.

Regulation near HPDP By OE (see “Acceleration of crankshaft”), is possible regulating a time Tout+Toin (FIG. 2B), when take place out of the WF to HPC 8 and combustion in cylinder 15, this regulation is according to a compromise between a good combustion (prefer the large time) and a small thermal loss (prefer the small time). As calculated, with compensation of gas force near HPDP, for M=1.25 kg, get Wr=480 rad/s and OE=21.6 J. If for better combustion need Wr=240 rad/s, with the same M=1.25 kg must OE=5.4 J, regulation of OE is explained above. If OE=0 and crankshaft 16 was fixated near LPDP, it may be fixated near HPDP and every bearing get static load Fmax/2=7180 N. May use standard roller bearing (HK2512) with permissible static load Co=15300 N, masse 21 g, internal d=25 mm, external D=32 mm, width b=12 mm. Example for rotating masse mR=0.3 kg is for this bearings (21*2=42 g), Aluminum shafts (tubes) with Chrome covering, d=25 mm length=30 mm (2*19=38 g), the rest 220 g are Aluminum crankshafts (FIG. 4B), plastic gears and belt 17 (no load, only synchronization), magnet rotors of electrical machines 22. For prior art with constant Wr, Fmax is dynamic load, so for prior art may use the same bearings, but 5-10 in parallel. As mentioned, in reciprocating roller bearings take place slide friction between rollers and separator, this friction loss is proportional to weight of rollers and separator.

### Synchronization to Expander 19

Expander 19 may be directly connected to wheel of a car. To regulate rotation moment, may regulate input valve of expander, combustion in expander, regulate output valve of the expander to avoid a large mistake of VER in the expander, or using more than a single expander. Controller 29 with using PPM, regulation of valve 18 and feedback from pressure sensor 32 inside HPC 8, must control frequency of cycles in cylinder 15 according to throughput of expander 19, so that pressure HP_in HPC 8 will be approximately constant.

With reference to FIG. 2B, there is shown changing volume of WC during working cycle.

With reference to FIG. 2C, there is shown parameters of working cycle of the engine (FIG. 2A) versus isothermal part of expansion in expander 19. It is close to graphical interpretation of mentioned Table_Z1. Due to isothermal expansion caused by combustion in expander 19, cycle work increase from 626 J (adiabatic expansion, efficiency Efa=62.1%) to 986 J (isothermal expansion, Ef=63.7%). Between this 2 points, Ef have a local minimum 60.1% if isothermal expansion take place up to volume in expander 19 is 18% from maximum volume of expander Veex, then expansion is adiabatic. Cycle work at this point is 842 J and power Qreg, transferred in regenerator 23, is only 4 J. This mode is bad. With isothermal expansion up to 47%, Ef=62.9%, cycle work 950 J, Qreg=207 J. This mode is near optimal. Full isothermal expansion cause large regenerator (Qreg=454 J), but useful effect is small: efficiency 63.7%, cycle work 986 J. Computer calculation include air friction loss in regenerator 23, supposing ideal thermal isolation. It is possible with vacuum “thermos”, but increase cost. Conclusion from FIG. 2C: For a small engine prefer adiabatic expander 19 and no regenerator (626 J, efa=62.1%). This engine is a small weight and cost.

With reference to FIG. 2D, there is shown valves WCLPIM 20, WCLPOM 21 for LP scavenging.

Drivers for all valves (20, 21, and 18) may include a spring with a large energy and power, to fast open and close a valve. When opened and closed, a valve fixated by electrical magnet, that can produce a large force to fixate it. This type of driver may find in prior art. If instead output valve 21 used a simple window, diminish useful part of piston stroke.

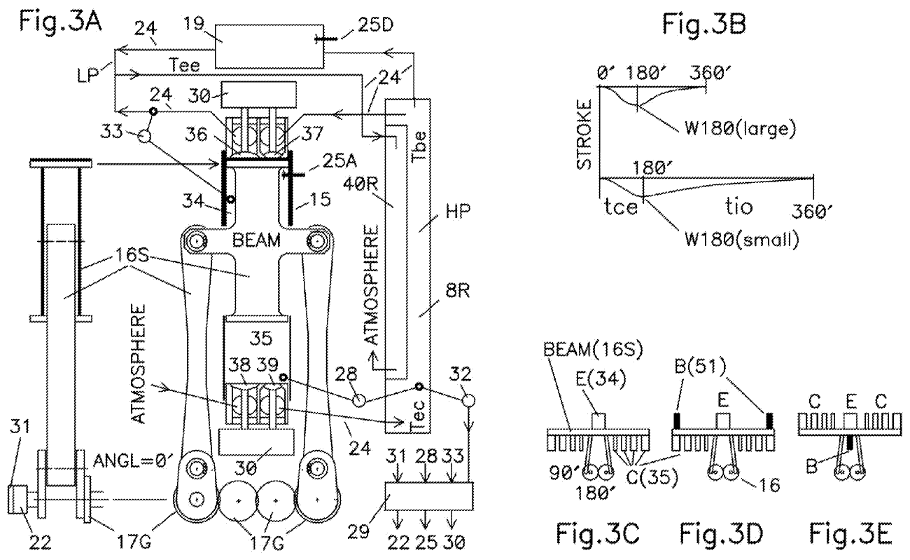

With reference to FIG. 3A, there is shown the ICE for power plant and transport, with PPM, efficiency>63%, with isothermal remote expander 19 and counter flow regenerator (8R and 40R). Main distinctions from prior art [1] U.S. Pat. No. 4,333,424A are: Hard connection between pistons of compressor 35 and expander 34 with the same compression and expansion energy, so they arranged as mentioned Zmachine; remote expander 19 arranged without transferring a work from this Zmachine; using mentioned PPM and synchronization Zmachine with remote expander 19.

Main distinctions from FIG. 2A are: Instead cylinder 15 used separated compressor 35 and isothermal expander 34 with small “kp”. Adiabatic compression with kp=1.5 (for example) is close to isothermal and thermodynamic efficiency of this engine with regenerator is as for cycle Carnot, but large size cause more vortex loss; so for FIG. 3C with 4 stage compressor, kp=12. No need blower 9 and no scavenging. Assembling 16S is without buffer 51, so as expansion work cause compression. Design is no balanced, but it may be balanced if add exactly the same “mirror” part as in FIG. 2A. Prefer that rotation speed is small, that cause better combustion and compression is closer to isothermal process (cooling not shown). Any case no thermal loss during isothermal expansion, caused by appropriate combustion, so Tbe=Tee and internal surface of expander 34 is with the same Tee (thermal isolation not shown). Output gas with temperature Tee from isothermal expander 34 and from remote isothermal expander 19 with the same Tee go to LPC 40R, that includes function of LP part of regenerator, and HPC 8R includes function of HP part of regenerator. At FIG. 2A, regenerator 23 is only optional. PPM is like for FIG. 2A, but distinctions, caused by absent of buffer 51, see below.

The embodiment on FIG. 3A comprising parts: 8R, 16S, 17G, 19, 22, 24, 25A, 25D, 28-33, 34-39, 40R. Below explains for several parts; all parts explained in NUMBERS OF PARTS FOR ALL DRAWINGS.
8R. HPC with function of regenerator, HP part.
16S. Piston and crankshaft assembling, no buffer, separated pistons for compressor 35 and expander 34.
17G. Synchronization gears; belt is needed, if a second Assembling 16S is used.
19. Expander, power output. There it named “remote isothermal expander”.
28. WCHPCIMDPS (sensor to measure a differential pressure between compressor 35 and HPC 8).
33. WCLPCDPS (Differential Pressure Sensor between WCE and LPC; at FIG. 2A, it is between WC and Atmosphere.

For FIG. 3A, pressure at input of LPC is a-little more then Atmospheric, that caused by gas friction loss.
34. WCE expander (instead cylinder 15; output of WCE go to regenerator 40R).
35. WCC compressor (instead cylinder 15). 36. Valve LP_out (instead 21). 37. Valve HP_in (no exist on FIG. 2A).
37. Valve HP_in (no exist on FIG. 2A). 38. Valve LP_in (instead 20). 39. Valve HP_out (instead 18).

Working cycle include simultaneously input stroke by compressor 35 and output stroke by expander 34, kinetic energy of assembling 16S diminish that caused by friction and vortex loss; then, simultaneously compression and expansion strokes, kinetic energy of assembling 16S increase, so as expansion energy a-little more then compression energy to compensate mentioned loss. Zwork=0. Air from compressor 35 with Tec goes to HPC 8R, where heated by combustion product from isothermal expander 34 and remote isothermal expander 19, this gas with Tee=Tbe go to input part 40R and then to Atmosphere with output temperature a-little more than Tec (if ideal regeneration, with Tee). Tec is a-little more than Tbc so as kv is small and so as compressor 35 is cooled. If Tec=Tbc and no loss, efficiency is as for cycle Carnot: Ef=1−Tbc/Tee. As mentioned, isothermal expansion is due to appropriate speed of combustion, caused by injectors 25A and 25D. Work of Expander 19 is output work, produced by the engine. If the engine used for a car, prefer placing expander 19 near a wheel, and regenerator 8R, 40R near expander 19, to diminish length of tubes 24 with hot compressed gas. Zmachine (34, 35) work with PPM algorithm with synchronization to expander 19 as explained for FIG. 2A. As option, Zmachine (for every embodiment) may include hydraulic piston pump, directly connected to assembling 16; this case, work of expander is more than work of compressor and over work is used by mentioned pump. Option with hydraulic pump cause addition loss and regulation problems and at FIG. 3A not shown.

With reference to FIG. 3B, there is shown cycle of Zmachine (FIG. 3A). On FIG. 3B: tce—compression and expansion time; tio—wide regulated time for input to compressor 35 and output from expander 34. For PPM are used principles explained for FIG. 2A. At crankshaft angle θ0 (according to FIG. 3A), rotation velocity is W0. Then begin compression, using energy from working stroke of Expander 34. At 180°, after tce, end compression and expansion, and rotation velocity is W180. From 180° to 360° (0°), during time tio, output from Expander 34 and input to Compressor 35; kinetic energy a-little diminish, that caused by vortex and friction loss. To compensate this loss, must W180>W0, and must EE>CE. Time tce caused by EE, by moving masses, by W0 and by loss. Time tio caused by moving masses, by W0 and by loss. Regulating W0 and tio is possible by small power electrical machine 22 that may work as engine, or generator, or no convert energy. For case “W180′(small)”, may see, that tce a-little depend from tio. If W0=0, or W180=0, may fixate crankshafts 16S. If need fast acceleration, may increase a time, when input valve (37) of WCE 34 is open, and vice versa.

With references to FIG. 3C, FIG. 3D, FIG. 2E, explain engine with multistage compressor, for example 4 stages. Signed: B—Buffer (51), E—Expander (34), C—Compressor (35). Expander 34 or remote expander 19 may be multistage as well, but this version not shown. For multistage compressor, must be several HPC with cooling in every HPC, except HPC with a largest HP, this HPC is regenerator (8R, 40R). Every stage comprising two cylinders for symmetrical load on beam (16).

With reference to FIG. 3C, explain engine with multistage compressor, using examples from Table_n.

Distinction between FIG. 3C and FIG. 3A: on FIG. 3C, n=4 stage compressor 35, with 8 pistons for symmetrical load. Output of every stage go to appropriate pressure storage HPC1 . . . HPC3 (not shown), where compressed air is cooled with constant pressure, but not cooled in HPC4 (not shown), so as the last stage, HPC4, is regenerator (8E, 40R). As at FIG. 3A, Zwork=0 and output of engine is from Expander 19.

### Example for n=4 Stage Compressor According to Table_n, String 4.2

Input to every Compressor stage (C) and output from Expander (E) begin from 180° with force Cfi=2127N. Cfi cause acceleration and input work: wcp=213 J, so during this input, wcp is converted to kinetic energy. Return this wcp will be during compression, from 0° to 180°. Fixation of crankshaft is possible near angle 180°, where static load on bearings is minimum, it is mentioned Cfi. Maximum acceleration caused by force Efz from expander and begin from 0° with force Efz−Cfi=12774−2127=10647N. For compression used mentioned wcp, returned from kinetic energy, and expansion energy (285 J), at all 213+285=498 J. In the table, instead mentioned expansion energy, may see negative energy we (−285 J), that get compressor from expander. All expansion energy used for compression (Zwork=0).

Due to converting between expansion and compression energy, stroke from 00 to 1800 is fast, with large accelerations, and stroke from 180° to 0° is slower, with only kinetic energy, redistributed between moving masses. Moving masses and compressed gas make functions of ES (Energy Source) and ER (Energy Receiver). Note: For n=1, expansion energy is 365 J>285 J, so as near isothermal 4-stage compressor (string 4.2) is better, then adiabatic (n=1). So, for n=1, Ef=63.5, but for string 4.2, Ef=71.5%, that is closer to Carnot cycle with Ef=75%.

### In Table_n, n is Quantity of Stages with Adiabatic Compression

Pbc=0.1 MPa. After last stage: Pec=Pbe=1.22 MPa. For 4 stages: kp1=kp2=kp3=kp4=1.87; kp1*kp2*kp3*kp4=12.2. Vbc=1000 cm³, Tbc=300° K. Cooling after 1 and 2 stages to Tbcn=322° K, but after 3 stage, to TbcN=305° K=Tbc for last, 4 stage. After regenerator (8R, 40R): TH=Tbe=Tee=1200° K. For Carnot cycle: Ef=1−Tbc/TH=75%.
Ef is efficiency of engine;
wcp is input work from all compressor stages;
we is work from expander, all this work used for compression (so Zwork=0);
Cf is summed forces from compressors 35 during output from all stages;
Cfi is summed forces from compressors 35 during input to all stages;
Efz is pic force from expander 34 of Zmachine.
Tec is output temperature of a last stage of compressor (gradus C). If dT in regenerator is 5° C.,
Tec+5° C. is temperature of output to atmosphere. The smaller Tec, the larger Efficiency Ef.
Tbcn is temperature after cooling in every stage, but TbcN is temperature before a last stage.

TABLE_n
Engine with multistage compressor.

| n | Ef, % | wcp, J | wc, J | Cf, N | Cfi, N | Efz, N | Tec, ° C. | Tbcn, ° K | TbcN, ° K |
|---|---|---|---|---|---|---|---|---|---|
| 6 | 72.1 | 350 | −280 | 6769 | 3501 | 12521 | 70 | 322 | 305 |
| n | Ef, % | wcp, J | wc, J | Cf, N | Cfi, N | Efz, N | Tec, ° C. | Tbcn, ° K | TbcN, ° K |
| 5 | 71.9 | 282 | −282 | 6219 | 2815 | 12622 | 79 | 322 | 305 |
| 4.1 | 71.1 | 217 | −289 | 5845 | 2175 | 12948 | 112 | 322 | 322 |
| 4.2 | 71.5 | 213 | −285 | 5748 | 2127 | 12774 | 91 | 322 | 305* |
| 4.3 | 71.9 | 211 | −281 | 5679 | 2108 | 12600 | 112 | 305 | 322 |
| 4.4 | 72.3 | 206 | −277 | 5583 | 2060 | 12422 | 91 | 305 | 305 |
| 3 | 70.9 | 143 | −291 | 5462 | 1432 | 13036 | 114 | 322 | 305 |
| 2 | 69.7 | 73 | −303 | 5760 | 726 | 13580 | 162 | 322 | |
| 1 | 63.6 | 0 | −365 | 11226 | 0 | 16344 | 348 | | |

From Table_n see, that efficiency ‘Ef’ increase with quantity of stages n, but n>4 seems too large, so as a small increasing of ‘Ef’ may be covered by loss in valves. Loss no including in calculations.
Distinctions between strings 4.1-4.4 are cooling Tbcn, TbcN, that cause changing of Ef and other parameters.

At string 4.4 is the best efficiency (between 4.1-4.4) due to the best cooling.

For a large cost and large power engine with perfect thermal isolated and a large regenerator (8R, 40R) calculated Ef>63% is close to reality.

For n=1, we=−365 J is compression energy, and it is compensated by work of expander 34. For n>1, summed compression energy for all stages (wcp+|wc|) increase, but it partly compensated by wcp (input to compressor), so the ‘wc’ part, that give expander, diminish and Ef increase.

Disadvantage of Embodiment FIG. 3C:

Using crankshaft to get and return energy wcp need large inertial moment of crankshaft, so more load on bearings during moving with PPM, so as inertial moment of crankshaft diminish acceleration an sufficiency part of gas force is placed on bearings; the rest part of gas force accelerate piston and connected parts.

Advantage: no need a buffer.

FIG. 3D. Distinction from FIG. 3C: have a buffer (b) at expander side of the beam. Part of work wcp get and return this buffer. If increase mean pressure in the buffer, more energy is stored in the buffer, so diminish rotation speed near 0°, but it increase near 180°. Advantage: Smaller inertial moment of crankshaft and load on bearings.

Note: even for 1 stage compressor, may use this buffer to have a large rotation speed near HPDP, but a smaller speed (up to 0) at LPDP.

FIG. 3E. A buffer is on crankshaft side, compressors and expander on opposite side. During working stroke of expander and input to compressors, 0° to 180°, charging the buffer, that discharging during compression, 180° to 360°. Both strokes are with the same acceleration. The crankshaft has minimal inertial moment, but maximal energy is in the buffer, minimum load on bearings. Fixation may be near 0° or near 180°.

With reference to FIG. 4A, there is shown the EHE for Sun power plant, ISC between cylinder 15 and HPC 8SH. The EHE is placed in focus of Sun concentrator. Remote Expander 19 connected to electrical generator 46. The embodiment comprising parts: 8, 9LP, 15, 16-22, 24, 26-33, 40, 41, 43-46, 48. Valve drivers 30 are not shown. Blower 9HP is optional.

The EHE is working according to Brayton cycle. If closed cycle, need hermetic envelope, and LP may be more than Atmospheric pressure. This cause heat from LPC 40 (long and large volume tubes, current initiated by Blower 9LP) is dissipated to Atmosphere. HPC 8 includes Sun Heater 8SH; it may be inside hermetic envelope (not shown) with low thermal conductive gas or vacuum; 8SH is separated from light source with glass that is low transparence for infra red ray. Heat transfer to and from Working Fluid (WF) is with constant pressure HP and LP correspondingly. Compression and expansion in cylinder 15 is adiabatic, with approximately the same kp=HP/LP and the same compression and expansion work (Zmachine). Volume of WF after Sun heater 8SH is more, than after compression in cylinder 15. Addition (due to heating to Tbe) volume of WF with HP=Pbe=Pec, HT=Tbe>Tec, across Thermal Isolated Tube 24 go to Remote Expander 19, where make useful work that converted to electricity by Electrical Generator 46. Remote parts are: 9LP, 19, 24, 40, 46. Other parts are small and placed from back side of Sun Heater 8SH and no dashing a Sun Concentrator (not shown).

With reference to FIG. 4B, there is shown piston and crankshafts assembling 16 with buffer 51, adjusted for PPM (see explain to FIG. 2A). Expansion energy is stored in buffer 51 and then used for compression; so, kinetic energy of assembling 16 may be zero at end expansion and end compression, and near these points crankshafts may be fixated if PPM. Buffer 51 may be connected to HPC (8SH) with long, small diameter tube, as explained above for FIG. 2A. Due to fixation of crankshafts may diminish a throughput across cylinder 15 and increase time for scavenging. This throughput must regulate so that Tbe after Sun Heater 8SH is optimal. If Tbe is too small, must diminish the throughput, and vice versa. Tbe measured by sensor TSSH 48 (FIG. 4A). About optimal Tbe, see below “PPM regulation”.

With reference to FIG. 4C, there is shown Inertial Scavenging (ISC) between cylinder 15 and HPC 8.

Below explain, how works controller 29. When volume of cylinder 15 is near Vec according to signal from RSS 31, and dP (measured by sensor WCHPCIMDPS 28) is near zero (dP=0), by driver 30 begin opening valve WCHPCO 18. This condition (must be volume Vec when dP=0) is according to regulation, explained below in “PPM regulation”. During initiating time tini (FIG. 4C), WF is pushing by piston of assembling 16 to input mean HPCIM 26, where WF get any kinetic energy. When dP, measured by sensor WCHPCOMDPS 43, is near zero, by driver 30 begin opening valve WCHPIM 41, and due to kinetic energy of WF, begin ISC. Hot WF with Tbe is moving from a hot part of the HPC (from HPCOM 44) to cylinder 15 across WCHPIM 41; simultaneously, WF with Tec is moving from cylinder 15 to a cool part of the HPC (to HPCIM 26). During input time tin, diminish kinetic energy of WF in HPCIM 26. According to signal from RSS 31, at volume Vbe, end closing of WCHPIM 41, WCHPCO 18. If normal scavenging, T27 (measured by HPCIMTS 27) before Sun Heater 8SH, is a—little more than Tec: T27>=Tec, due to a small mixing between gases with temperatures Tec and Tbe, so as Tec<Tbe. Optimal T27 (a-little more than Tec) cause maximum efficiency. Tbe measured by TSSH 48, and Tec=Tbc*(Vbc/Vec)^{(ka-1)} where Tbc measured by TSBC 45 and Vec calculated from signal of position sensor RSS 31 when begin open WCHPCO 18. So, comparing Tec (calculated from measured Tbc) and T27 (measured), may adjust the optimal scavenging. If measuring HP by pressure sensor HPCPS 32 (if exist), may calculate T27 by another way. Any case, ISC depend from construction parameters (for example Vec/Vmin), by regulation of WCHPIM 41 and WCHPCO 18, by crankshaft fixation time at point Vmin (this fixation is possible by PPM—see below).

End expansion volume Vee detected by RSS 31, then WCLPOM 21 and WCLPIM 20 are opening by drivers 30, and due to blower 9LP, WF with parameters Pbc=LP and Tbc=LT go inside cylinder 15, while WF with Tee go to LPC 40. Instead blower 9LP, possible ISC, for example see explanation of FIG. 2A.

Version with additional Blower 9HP may be needed in case of large pressure drop across Heater 9SH, causing bad work of ISC. Blower 9HP gets addition power, but for this version may be Vec=Vmin and so diminishes friction loss. Every blower 9HP, 9LP is arranged as a rotating mean, capable to working as a turbine or as a compressor according to difference of pressure between input and output of the rotating mean. This rotating mean, when connected to electrical machine, is working as electrical generator or electrical motor and is connected to electrical accumulator across electrical Controller (29). Electrical machine of Blower 9HP is placed out of the hot zone, with appropriate sealing envelope (not shown). Obviously, appropriate control of valves (20, 21, 18, 41) may cause large energy of gas flow when scavenging begins. This energy may be accumulated by Blowers 9LP, 9HP, but this case is more practical for ICE (see explanation below about dWv to Table_Zwork).

### PPM Regulation

Optimal Tbe selected as a compromise between infrared loss from 8SH when Tbe is high, and small Ef, when Tbe is small; Tbe measured by TSSH 48. A throughput of Remote Expander 19 is regulated to keep pressure HP, measured by HPCPS 32, near optimal. If HP is too small, must diminish throughput of expander 19, and vice versa. When HP is optimal, mentioned condition “Vec when dp=0” is true. For example, may regulate throughput of expander 19 by regulating input and output valves of expander 19. Note, that for car, power of expander 19 is according to load, but for Sun Power Plant—vice versa: power of electrical generator 46 and, so, expander 19, must be according to Sun Heater.

If used Electrical Generator 46 synchronous type, this regulation cause changing rotating moment of Electrical Generator 46 and so changing electrical current and power, that must be according to power of Sun Heater 8SH. Receiving surface of 8SH is sufficiency more than a surface normal to concentrated Sun rays. Most ray energy, that go across this normal surface, is absorbed by the receiving surface of 8SH, but infra-red loss is equivalent to loss from the “virtual” normal surface, heated to TH+dt, where dt may be, for example, 20° C. and need for thermal transfer from 8SH to WF.

Example from Computer Calculation.

HT=750° K=477° C., LP=7 atm, HP=56 atm, Ef=42% with calculated thermal and friction loss in cylinder 15. For ideal Brayton cycle: Ef=44.6%; for Carnot cycle: Ef=(HT−LT)/HT=60%. Diameter of cylinder 15 is 45 mm, stroke 2×40 mm, cycle work=81 J, so power is 4 kW for 3000 cycles/min. If common efficiency (including loss in Sun concentrator, heater 8SH, expander 19, generator 46) is 25%, and power of Sun radiation is 1 kW/m², need Sun concentrator surface 16 m². Calculated for this EHE, good Ef=42% caused by scavenging between Cylinder 15 and HPC 8, by PPM regulation and due to using large, but low cost, high efficiency remote expander 19 and generator 46, that impossible for prior art. To increase Ef, must increase HT, that is possible with using special glass (available today), transparent for Sun Spector, but no transparent for infra red loss from heating surface of heater 8SH.

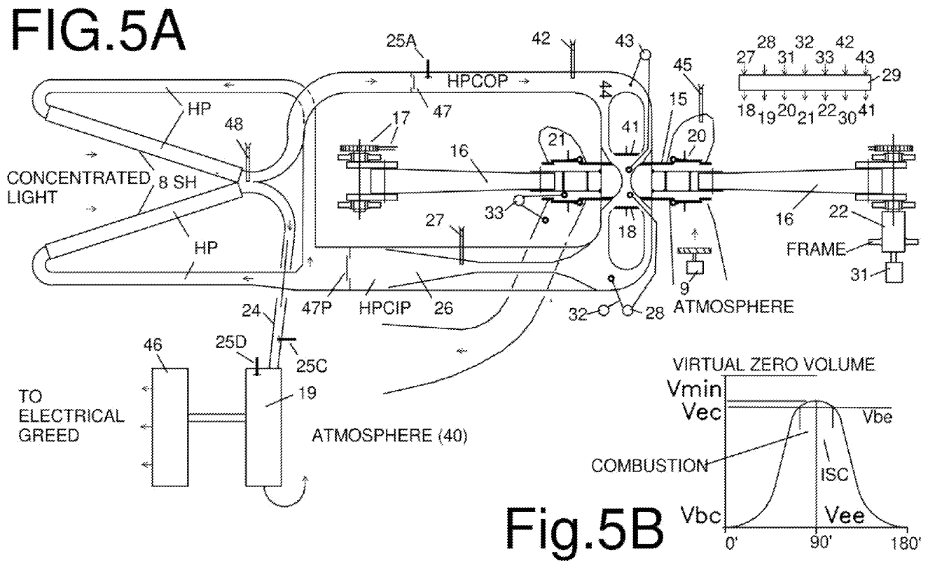

With reference to FIG. 5A, there is shown the ECE with hybrid Sun heating and combustion and remote expander 19. The embodiment (FIG. 5A) comprising parts: 8, 9, 15, 16-22, 25-33, 40-48. Valve Driver 30 not shown.

HPC 8 include Sun Heater 8SH, and HPC 8 separated by valve HPSDV 47 to an input part HPCIP and an output part HPCOP (80P). HPSDV 47 may be directly controlled by dP between two sides of it, or from a driver (not shown), activated by sensor of this dP (not shown), this case dP may be near zero due to high sensitivity of this sensor.

By combustion in the HPCOP, initiating scavenging between WC (cylinder 15) and HPC, that includes parts 8SH, 26, and 44. Is used PPM. LPC is Atmosphere, WF is air, open cycle, but Versions “P” and “47P” are without combustion (so may be LP>0.1 MPa, closing cycle). Scavenging between WC and LPC is initiated by blower 9.

With reference to FIG. 5B, there is shown scavenging, initiated by mentioned combustion.

After end compression in Cylinder 15 (at volume Vec), begin opening of WCHPCO 18, WCHPIM 41, and begin combustion in the HPCOP, caused by Injector 25A. Combusted product from previously cycle pushed to cylinder 15, so as HPSDV 47 is closed and Injector 25A is placed near HPSDV 47. Simultaneously, compressed air pushed to the HPCIP. So, heat expansion of WF in HPCOP initiates scavenging between Cylinder 15 and HPC 8; scavenging continue when HPSDV 47 is open. When volume of cylinder 15 return Vbe=Vec, end closing of valves WCHPCO 18, WCHPIM 41. So as scavenging caused by combustion in HPCOP, possible Vec=Vmin. So as combustion may continue during scavenging, this scavenging may be fast. May end combustion before than valves 18, 41 are closed, this causes ISC to begin. Scavenging time, when valves 18, 41 are opened, adjusted by controller 29 with feedback from temperature T27, measured by sensor 27, placed in HPCIP. About optimal T27 see explain to FIG. 4A-4C; with or without Sun heating, optimal T27 cause maximum Ef Optimal T27 a-little more then Tec. Addition combustion is possible by injectors 25D (before expander 19) and 25C. Work of these injectors must be synchronistic with work of expander 19 and cylinder 15 to avoid reversed current across cylinder 15 and Sun neater 8SH.

Version “P”.

This case does not need combustion. Main principle: Scavenging between WC and HPC proceeds by changing volume in Expander 19, and then using ISC. By PPM, end compression in Cylinder 15 is synchronistic to at least a part of input stroke of Expander 19, that cause diminishing pressure in part of HPC named HPCIP, while HPSDV 47 is closed. Signals from WCHPCIMDPS 28 and WCHPCOMDPS 43, initiate opening WCHPCO 18 and WCHPIM 41 by controller 29 with appropriate drivers 30, so begin scavenging. Then, due to kinetic energy of WF, pressure in HPCOP and HPCOM 44 diminish, that cause opening HPSDV 47 and scavenging continue with ISC. After scavenging time tsc (see above), valves 18 and 41 are closed.

Version 47P.

Instead HPSDV 47, HPSDV 47P is used. Scavenging between Cylinder 15 and HPC 8 proceeds by combination of two factors: increasing pressure in part 8SH due to heating from Sun light, and then ISC. HPC 8 is separated to two parts 8HS and HPCIP with valve HPSDV 47P. When valves HPSDV 47, WCHPIM 41, and WCHPCO 18 are closed, part 8SH is (temporarily) hermetically sealed by WCHPIM 41 and WCHPCO 18, and heating by Sun light causes changing ratio between pressures in parts 8SH and HPCIP. Opening WCHPIM 41 and WCHPCO 18, initiates flow of the WF between the two parts across Cylinder 15; when ratio between pressures in parts 8HS and HPCIP is close to 1, opening the HPSDV 47, thereby proceeding with ISC, with control valves WCHPIM 41, WCHPCO 18 and time tsc as explained. During scavenging, input valve (not shown) of Expander 19 is closed.

Comparing Between Versions FIG. 5A and FIG. 4A (“+” if Version FIG. 5A is Better):
− Heat loss (h_loss) for FIG. 5A is more, then for FIG. 4A. It is so as h_loss to surface is proportional to p^{(0.3 . . . 0.5)}, but power is proportional to P, so h_loss/power is smaller in closed cycle (FIG. 4A) if LP>0.1 MPa. Versions “P” and “47P” may work in closed cycle. To switch between open and closed cycle, need: a valve that may connect output from valves 20 to input valves 21 across addition heat exchanger; a compressor to regulate LP; hermetic envelope; all this not shown.
+ Obviously, that combustion energy adds power. Even with small combustion energy, scavenging between Cylinder 15 and HPC 8 is good and possible Vec=Vmin, so smaller friction loss, caused by moving piston 16 under HP; smaller time for scavenging due to more energy for scavenging, so diminish thermal loss.
+ With combustion, may be more efficiency of using Sun energy. Example: For Brayton cycle, Efa=(Tec−Tbc)/Tec. For FIG. 4A and FIG. 5A, must Tec<T48 (measured by sensor TSSH 48), else Sun heater 8SH cannot transfer heat. In example for FIG. 4A, Tbe=HT=T48=750° K. T48 limited by infra red loss and optimal T48 is the same for FIG. 4A and FIG. 5A. Suppose: For both cases, Tbc=300° K, Tec=700° K. For FIG. 5A, in cylinder 15: Tbe=T42=1000° K, and the same Tbe for Expander 19 due to Injectors 25C or 25D. Both cases, if no loss, Efa=57%, and CE is the same, and Zwork=0. For FIG. 4A: EE/CE=Tbe/Tec=1.071, EE4=0.071*CE. For FIG. 5A: EE/CE=1000/700=1.429, EE5=0.429*CE, where EE4, EE5 are Expander Energy (useful work) for FIG. 4A, FIG. 5A if no loss. Both cases efficiency of compression and expansion strokes in Zmachine (cylinder 15) suppose Efz=0.97, efficiency of Expander 19 suppose Efe=0.98. For FIG. 4A, loss4=(1−Efz)*2*CE+(1−Efe)*EE4=0.061*CE. With this loss: EE4L=0.01*CE; Ef4=Efa*EE4L/EE4=8% (instead 57% if no loss). For FIG. 5A: loss5=(1−Efz)*2*CE+(1−Efe)*EE5=0.0686; EE5L=0.360; Ef5=Efa*EE5L/EE5=48%. This 48% is Ef for using Sun energy and fuel. If Tec<700° K, Ef4>8%, but Ef5<48%. With separated combustion and Sun engines, may be independent parameters for best Ef of both engines, but cost of the power plant increase. The compromise is version FIG. 5 with using only Sun or only combustion mode, and combination (Sun and combustion) by computer with using all factors.

With reference to FIG. 6, there is shown the heat pump for combined heat pumping and producing energy from a wind, with remote Compressor 7 connected to a wind turbine 49; open cycle; at least a single WC (15) with scavenging by blowers 9LP, 9HP and regulation Zwork near zero, with regulated valves and PPM regulation of throughput.

The embodiment comprising parts: 7, 8B, 8C, 8H, 9LP, 9HP, 10, 15-22, 24, 26-33, 40, 41, 43, 44-46, 49, 50, 52-56, 58 and optionally 47.

On View A-A may see items 26 and 44, designed to improve inertial scavenging. Valve drivers 30 are not shown.

The Heat pump working according to open reverse Brayton cycle, LPC 40 is atmosphere.

Output of Compressor 7 across Distributor 50 connected to Cool part 8C of HPC and to thermal isolated Buffer Volume 8B, that across on/off valve 54 connected to Expander 19, mechanically connected to Electrical Generator 46.

At cooling mode, the LPC is a cooling room, and the HPC cooled by external air.

At heating mode, the LPC is atmosphere, and the HPC cooled by a room air.

Blowers (turbines) 9LP, 9HP, 9E are working during all cycle from any small power source.

Working Algorithm Includes:

Closing WCHPIM 41 and WCHPCO 18, thereby separating the HPC 8 to two parts (8C, 8H); changing a ratio between pressures of WF in these parts, using blower 9HP; opening the WCHPIM 41 and WCHPCO 18, and so initiating flow of the WF between parts 8C and 8H across Cylinder 15, then using ISC; closing the WCHPIM 41 and WCHPCO 18 to end ISC. So, after compression in Cylinder 15, scavenging is initiated by Blower 9HP.

After expansion in Cylinder 15, scavenging initiated by Blower 9LP.

Air current across heating section of Heat exchanger 10 initiated by Blower 9E.

### Current of Air During Cooling Cycle

Input air from room—Valve 52cIR—compression in Cylinder 15—sink heat to Atmosphere in Heat Exchanger 10 with heating section connected by valve 52cEA—expansion—Valve 52cOR—to room.

### Current of Air During Heating Cycle

Input air from Atmosphere—Valve 52HIA—compression in Cylinder 15—sink heat to room in Heat Exchanger 10 with heating section connected by valve 52HER—expansion—Valve 52HOA—to Atmosphere.

All sections of Valve 52 may be connected together mechanically.

Piston assembling 16 is shown at HPDP (Dead Point when end compression), so volume of Cylinder 15 (WC) is Vmin. Due to scavenging after end compression, Vmin is large and so surfaces of valves WCHPCO 18 and WCHPIM 41 may be large, vortex loss and time for scavenging is small.

HP scavenging from volume 8C across cylinder 15 to volume 8H is initiated by blower 9HP when valves WCHPCO 18 and WCHPIM 41 are open. Power of blower 9HP is regulated by controller 29 for optimal HP scavenging. It is optimal when temperature after output from cylinder 15, T27, measured by HPCIMTS 27, is a-little smaller than Tec; Tec=Tbc*kv^{(ka-1)}, Tbc measured by TSBC 45, kv may be regulated by valves 20 and 21. T27<Tec due to partly mixing in cylinder 15 with input air with Tbe, measured by TSBE 55. In case of over scavenging, a large part of input air with Tbe goes to output from Cylinder 15, so T27 sufficiency smaller then Tec. Over scavenging cause increasing of vortex loss.

During HP scavenging, air with begin parameters HP, T27, is pushed across Heat Exchanger 10 by Blower 9HP and is cooled. Air across heating section of Heat Exchanger 10, is pushed by Blower 9E.

If the Heat pump working with cooling mode, heat from compressed air (T27, HP) is sinking to Atmosphere; with heating mode, this heat sinking to a room; reconnection between Atmosphere and the room by Valves 52cEA, 52HER.

After end expansion in cylinder 15, WCLPIM 20 and WCLPOM 21 must be open, and cooled (due to adiabatic expansion) air across 52cOR go to the room; at heating mode, this cooled air go to Atmosphere across 52HOA.

Optimal LP scavenging is controlled by: sensor TSBC 45, measuring Tbc, that is as well temperature of scavenging air in input of cylinder 15; by sensor TSILPC 58, measuring mean temperature after output from cylinder 15, it is T58; by TSBE 55, measuring Tbe. For optimal LP scavenging, T58 is a-little more than Tee, Tee=Tbe/kv^{(ka-1)}. If over scavenging, T58 is too large, that caused by mixing with air with Tbc. If scavenging is not good (for example, a small time for scavenging), T58 is close to Tee and throughput of cool air diminish, “pumping” of heat energy diminish, while mechanical loss is approximately the same and so efficiency of the heat pump diminish.

Over scavenging not diminish “pumping” of heat energy, but increase vortex loss. For air conditioner, over scavenging is not critical (in any case, output air is mixed with hot air in the room), but prefer avoid over scavenging if the heat pump used for refrigerator.

Throughput of the Heat Pump Controlled by PPM.

If HP, measured by HPCPS 32, increase over desired level, part of throughput of Remote Compressor 7 must be directed to buffer 8B across Distributor 50 and thermal isolated tube 24.

Buffer 8B is large volume, thermal isolated and used as energy source for Remote Expander 19, connected to Electrical Generator 46. Pressure inside Buffer 8B is measured by HPCBPS 56. If this pressure is smaller then desired minimum, must close valve 54, and vice versa.

If throughput of Remote Compressor 7 is too small, may using an addition compressor (not shown) from any energy source, for example from Remote Expander 19, reconnecting it to the addition compressor.

One of advantages of Heat Pump (FIG. 6) against prior art [3]: piston stroke is sufficiency smaller than for the prior art, and so diminish friction loss; diminish loss for output from cylinder 15 to HPC due to large surfaces of WCHPCO 18 and WCHPIM 41. Due to PPM, is possible to fixate crankshaft 16 at LPDP and so to diminish loss for scavenging of air between cylinder 15 and LPC.

Version with Valve HPSDV 47 may work without Blower 9HP, but preferably with using for heat pump only mentioned addition compressor (below named “compressor”). This method for the heat pump, with scavenging at least by changing of an external volume (in this case, the volume in a compressor of positive displacement type). For this version, providing phase difference sensors (not shown), arranged to detect difference between cycle phases of Cylinder 15 and the compressor. Controller 29 provides synchronization between cycles of Cylinder 15 and the compressor, using signals from HPCPS 32 and the phase difference sensors, so that pressure in HPC 8 will be approximately as desired, and after end compression in Cylinder 15, take place at least a part of an output stroke of the compressor. So, when HPSDV 47 is closed, initiating ISC. Adjusting the optimal scavenging duration, for optimal T27, as explained above.

Synchronization with Compressor 7, working from wind energy (and so with wide swing of rotation speed) may be problematic, so this version is practical only with mentioned “additional compressor”.

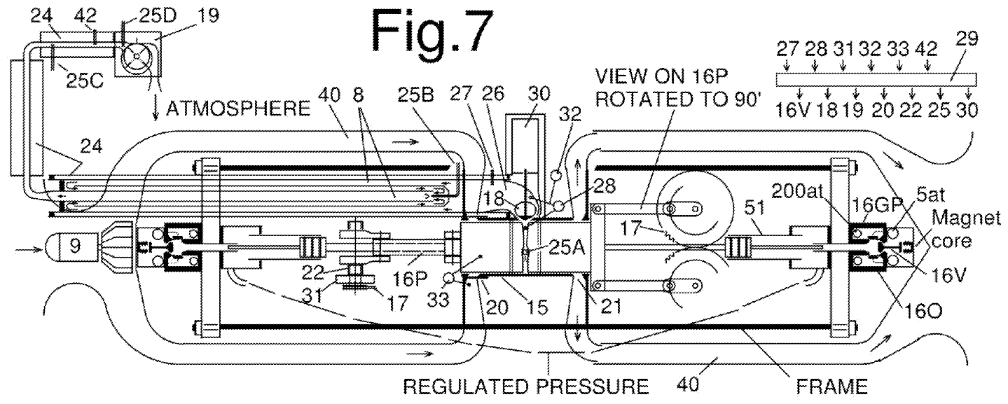

With reference to FIG. 7, there is shown the ICE that is very close to explained for FIG. 2A. Distinction from FIG. 2A is comprising a regulated Hydraulic pump 16GP as energy receiver to use Zwork for charging a hydraulic accumulator (not shown), so Zwork may be large, while for FIG. 2A, Zwork must be small, so as small power electrical machine 22, used for PPM, cannot get a large Zwork. So as Hydraulic pump 16GP is regulated, prefer using regulated pressure in Buffer 51. Version FIG. 7 with combined mechanical and hydraulic power need, for example, in construction engineering. Another using is for a car, for example, with hydraulic motors for front wheels, and expanders—for rear wheels, with option to restore energy in hydraulic accumulator.

The embodiment (FIG. 7) comprising parts: 8, 9, 15, 16P, 16GP, 16V, 16O, 18, 19, 20, 21, 22, 24-33, 40, 42. Driver 30 for sliding valve 20 is not shown. Instead valve 21 using a window.

Calculations are for adiabatic process. Above in “Explain to Table_Z1” mentioned, that heat loss may diminish Ef to 1.5-2.5%. Mass of fuel is smaller than 5% from mass of air. Volume of HPC is 1500 cm³; Vbc=1000 cm³, Tbc=300° K, Pbc=0.1 MPa, Pec=3.975 MPa, Tec=859° K; Tbe=Tmax=2000° K; Pee=0.1043 MPa, Tee=697° K. Virtual work, workv=0.06 J, may be caused by expansion from Pee, Tee, Vee=Vbc, to virtual: Pbc, 688° K, 1030 cm³. This work named “virtual”, so as it may be used (for example, by turbine), but often it is not used even in prior art, where workv is large. There, workv is small and may be used for ISC. Used heat=826 J. Tbe/Tee=Tec/Tbc=2.87.

Work: 0.06 (workv)+20.5 (Zwork)+510 (expander)=530 J; Ef.=530/826=64%, if no loss of heat to walls of WC and expander. Temperature in HPC, THPCes=1246° K, calculated supposing a full mixing inside cylinder 15 during output to HPC, caused by combustion. In Table_Zwork (below) may see, that THPCes caused by Vbe. Really, THPCes is smaller, and without mentioned mixing, THPCes=Tec. To get a full power, must addition combustion in HPC 8 or in expander 19, and combustion in cylinder 15 to Tmax. Combustion in HPC 8 or expander 19 is better than in WC (cylinder 15) so as more time, more temperature at begin combustion, better mixing. So, for the same fuel, output from expander is clearer than output from WC. So, for clearer output, prefer to diminish output from WC. Below, mass of combusted product, that go from WC to atmosphere, named Moutwc, and all output named Mout (for a full power). Both Moutwc and Mout caused by the same proportion coefficient “k” (according to combustion energy of fuel, that is near 47e6 J/kg; mass air/fuel, is 15-20 for a full power).

From mass of air in cycle, Mbc=1161 mg, and mass, displaced from WC to HPC, mtoHPC=639 mg, may calculate Moutwc/Mout. So, Moutwc=(Mbc−mtoHPC)*(Tmax−Tec)*k; Mout=Mbc*(Tmax−Tec)*k; Moutwc/Mout=X=(Mbc−mtoHPC)/Mbc=522/1161=0.45. Calculating X by another way: X=300/688*1030/1000=0.45.

Due to PPM, combustion inside WC may be optimal, so as possible regulation a time for combustion (see explain of PPM for FIG. 2A). So, 45% of fuel is combusted inside WC with the same or better quality than in prior art ICE, and the rest 55% combusted with the best quality inside HPC. To save lifetime of expander valves, and to diminish heat loss in HPC, a part of fuel may be combusted in the expander during input from HPC. Combustion in the expander begins from a high T and so it is good.

Zwork used by the Hydraulic pump 16G, that include electrical controlled input valve 16V and automatic Output Valves 16O. As example, mean velocity of piston and plunger (assembling 16P) is 8 m/s and it is velocity of oil mass 5G; kinetic energy of oil is lost and for 2 pumps and 2 strokes is 0.3 J (for FIG. 7, cycle work=530*1256/1000=665 J for 2 pistons). If high pressure of oil in hydraulic accumulator is 200 atm, for working stroke of pump 5 cm³, maximum work for 2 pumps is 200 J. Minimum is zero, if input valve 16V closed at end of working stroke.

For oil velocity 4 m/s across valve 16V, dP=0.8N/cm². Surface of valve 16V is 2 cm², so an electrical magnet must make 1.6N (in this case, the magnetic gap>0) to compensate this dP. If acceleration of valve 16V is 1 mm during 1 ms, and mass 5 g, mean acceleration force from spring is 10 N, pic force is 20 N. So, the electrical magnet must make>21.6N when magnetic gap is zero. Electrical magnet at FIG. 7 with surface of core 1 cm² may make force 160 N>21.6N.

Calculated above small loss (0.3 J=0.05% from the cycle work) in valve 16V is due to fixation of assembling 16G by crankshaft, but not by any valve. For prior art [9], fixation caused by closing a valve (named in the Prior Art a FREQUENCY CONTROL VALVE), and driver of it must compensate force, for this example: 2000 N/2 cm²*2 cm²=4000 N, so construction of this valve must be another and loss in it is more. From prior art [9]: “ . . . the frequency control valve of 50 bar would for example result in an energy loss of 31 J. Compared to a total pump work of 410 J, this would be a loss of 7.7% . . . . This then sets the requirements for the frequency control valve: a rather large valve with an extremely fast opening response time. An opening time of a few milliseconds is acceptable since the valve can start to open at the end of the previous stroke . . . ”.

Compare loss 7.7% in valve of prior art [9], with loss 0.05% in valve according to FIG. 7. This small loss is due to PPM, described for FIG. 2A.

### Table_Zwork Illustrate Working of Engine with Hydraulic Pump (FIG. 7)

Zwork (Zw)=EWz−CWz, where EWz is expansion, and CWz is compression works in Zmachine; if Zw>>0, it used by the hydraulic pump. Main output (EW) is from Expander. dWv=virtual work for expansion from Pee, Vee=1000 cm³, to 1 atm up to virtual volume Vwcv,cm³; work=Zw+dWv+EW, Ef=work/heat (if no loss). Vwcv no exist in reality in this embodiment; it included to “work”, so as it may be used by any addition volume (Vwcv−Vee), but it is not practical. CWz=376 J, Pec39.7 atm, Tec859K, Tmax in WC=1900° K; gas with THPCes from HPC go to expander; Vec=72, Vmin=67 cm³. Changing of parameters caused by begin expansion volume Vbe.

TABLE_Zwork
Engine with hydraulic pump

| Zw | Vbe | Tee | Pee | dWv | Vwcv | Work | EWJ | THPCes | Ef |
|---|---|---|---|---|---|---|---|---|---|
| J | cm³ | ° K | MPa | J | cm³ | J | J | ° K | % |
| 18.9 | 71.5 | 662 | 0.104 | 0.05 | 1026 | 497 | 478 | 1216 | 64.2 |
| 108 | 81.5 | 697 | 0.124 | 1.87* | 1166 | 520 | 410 | 1179 | 64.5 |
| 194 | 91.5 | 730 | 0.145 | 6.09 | 1303 | 549 | 349 | 1153 | 64.7 |
| 236 | 96.5 | 746 | 0.156 | 9.04 | 1371 | 565 | 319 | 1140 | 64.8 |

From TableZwork may see, that Zw (Zwork) may be a sufficiency part of the full output work (530 J); for prior art, Zw is a full work of engine and so dWv, that practically not used (to use it, must expansion from Vee=1000 cm³ to Vwcv, that for prior art is sufficiency more, than in Table_Zwork), cause a loss of efficiency. In embodiment FIG. 7, this loss is very small. Working mode like in the last string may be used when need a large hydraulic power (Zw=236 J). So as for this case THPCes is minimum, addition combustion in expander may sufficiency increase a power (if no regenerator, prefer use combustion in expander only for a short time to get a pic power).
String with dWv=1.87 J is optimal, and dWv used for inertial scavenging, that helps Blower 9 (if needed)

Below example about friction loss in bearings and rings (FIG. 7), this loss is smaller than for Prior Art [3]. This example is true as well for FIG. 2A and other embodiments with reciprocating piston. Parameters of Zmachine on FIG. 7: cylinder D=112.8 mM, stroke 94 mM, a single ring with height 1 mM and friction coefficient fr=0.3, crankshaft bearings D=35 mM and friction coefficient bfr=0.0025 (needle roller bearings). Cycle work 530 J for Vbc=1000 cm³; Vec=72 cm³, Pec=3.975 MPa. In Table_fr: fzr, bfr=friction loss by ring and bearings; dWv, Zw explained for Table_Zwork.

TABLE_fr
Friction loss

| Vmin | fzr | bfr | dWv | Zw |
|---|---|---|---|---|
| cm³ | J | J | J | J |
| 71.5 | 4.1 | 0.3 | 0.07 | 20.6 |
| 56.5 | 4.73 | 2.9 | 0.05 | 19.7 |
| 46.5 | 5.13 | 3.8 | 0.03 | 15.4 |

From the last string may see, that if after end compression at Vec=72 cm³, piston continue moving to Vmin=46.5 cm³ with pushing compressed gas to HPC, friction loss is maximum: 5.13+3.8=8.93 J, that caused by moving piston and crankshaft against Pec. Then displacing compressed gas continues by any of methods explained above. For Prior Art [3] with proportional sizes, Vmin=0, all gas pushed by piston, and loss is sufficiency more than for Vmin=46.5 cm³.

Optimal is Vmin=71.5 cm²: due to near zero moving piston after end compression, friction loss is minimum (4.4 J). dWv=0.07 J used for inertial scavenging, that help to Blower 9.

1. Method of operating a Positive Displacement Heat Machine (PDHM), the PDHM provided with at least a single Working Chamber (WC), arranged to change its volume during at least a part of a thermodynamic cycle and to transfer mechanical energy to/from a compressible Working Fluid (WF); the thermodynamic cycle including compression and expansion entailing Lower Pressure (LP) of the WF; the thermodynamic cycle further including Higher Pressure (HP), HP>LP; the thermodynamic cycle also including a Lowest Temperature (LT) of the WF; the thermodynamic cycle further including a High Temperature (HT), HT>LT; the PDHM is further provided with at least a single Low Pressure Chamber (LPC, 40), containing the WF with said LP; the LPC may be the atmosphere, otherwise the LPC is provided with means, arranged for thermal transfer between the LPC and an external medium; the LPC is provided with an LPC Input Part (LPCIP) for the WF and an LPC Output Part (LPCOP) for the WF with changed temperature; at least a single Low Pressure Input Mean (WCLPIM, 20) is provided between the WC and the LPCOP, and at least a single Low Pressure Output Mean (WCLPOM, 21) is provided between the WC and LPCIP, both arranged as controllable openings; the PDHM providing with at least a single High Pressure Chamber (HPC, 8), that contains the WF with said pressure HP; if said PDHM is the heat pump, the HPC 8 arranged for cooling the WF by heat transfer to external medium; at least a single High Pressure Controllable Opening (WCHPCO, 18) is provided between the WC and HPC; the thermodynamic cycle comprising:
1.1. moving at least a part of the WF from said WC to said LPCIP across said WCLPOM 21;
1.2. moving at least a part of the WF from said LPCOP to said WC across said WCLPIM 20;
1.3. changing a temperature of the WF in said LPC 40, and/or in said WC, and/or in said HPC 8;
1.4. compressing the WF in said WC with closed WCLPOM 21, WCLPIM 20, WCHPCO 18;
1.5. moving the WF across said WCHPCO 18;
1.6. expanding the WF inside said WC with closed WCHPCO 18;
Characterized in that:
during step 1.5, after ending compression in said WC, and when pressure in said WC is close to pressure in said HPC 8, opening said WCHPCO 18 and displacing at least a part of the WF between said WC and HPC 8, such that displacement of said part is not caused by changing the volume of the WC.

2. The method of claim 1, wherein at least a part of compressed WF is displaced between said WC and HPC 8, by the operations selected from the group, consisting of:
a. changing at least a single mechanical volume; and whenever changing a volume of the WC (Vwc), displacing only a part of the WF by changing said Vwc;
b. changing volume of any WF;
c. using kinetic energy of any WF;
d. changing pressure of any WF;
e. any combination of two or more of the above;
where several combinations are selected from the group, consisting of:
2.1. Combination of “a” and “b” for the Internal Heating Engine (IHE), further comprising: according to “a”, displacing a part of WF from said WC to HPC 8 by diminishing said Vwc, while said WCHPCO 18 is open; according to “b”, displacing additional part of the WF from said WC to HPC 8 by heating, thereby expanding a part of the WF inside said WC, where the heating part is far from said WCHPCO 18, and said additional part is closer to said WCHPCO 18;
2.2. according to “c” for the PDHM, using Inertial SCavenging (ISC), thereby initiating moving a part of the WF from said WC and initiating moving another part of the WF to said WC by any of the operations “a”, “b”, “d”, and continuing this moving due to kinetic energy of the WF and, optionally, due to kinetic energy of a scavenging means, if used; providing in the WC with a High Pressure Input Mean (WCHPIM 41), arranged as a controllable opening from the HPC 8 to the WC; initiating moving of the WF across said WCHPCO 18 and WCHPIM 41 or one of them, then opening WCHPIM 41 and WCHPCO 18 for ISC;
2.3. for the PDHM, scavenging across said WC by a blower, the blower may be based on the positive displacement principle, according to “a”, or by using kinetic energy of any part of the WF according to “c”, or using both “a” and “c”;
2.4. according to “a”, scavenging in the PDHM from and to said WC at least by changing an external volume, that is not volume of the WC; then according to “c” using ISC,
2.5. combination of “b” and “c” for the PDHM; separating the HPC 8 to two parts with a Single Direction Valve (HPSDV, 47) between them, and when the HPSDV 47 is closed, but said WCHPIM 41 and WCHPCO 18 are open, changing the ratio between temperatures of the WF in said two parts, to initiate a flow of the WF between said two parts across said WC due to changing volume of the WF according to “b”; according to “c”, using ISC to continue the flow across said WC and said two parts while said HPSDV 47 is open;
2.6. combination of “d” and “b” and “c” for the PDHM; separating the HPC 8 to two parts with said HPSDV 47, and when said HPSDV 47, WCHPIM 41, and WCHPCO 18 are closed, changing a ratio between temperatures of the WF in said two parts, so changing a ratio between pressures to be different from 1, this process take place with constant volume according to “d”; open said WCHPIM 41 and WCHPCO 18, initiating a flow of the WF between said two parts of the HPC across said WC according to “d”; when the ratio between pressures in said two parts of the HPC return approximately to 1, continue changing the ratio between temperatures with approximately constant pressure according to “b” and opening said HPSDV 47, whereby using ISC according to “c”, and so continue the flow across said WC, and said two parts of the HPC, and said HPSDV 47; to end scavenging, closing said HPSDV 47, WCHPIM 41 and WCHPCO 18;
2.7. combination of “d” and “c” for the PDHM; separating the HPC to two parts with said HPSDV 47, and when said HPSDV 47, and WCHPIM 41, and WCHPCO 18 are closed, changing a ratio between pressures of WF in these parts;
opening said WCHPIM 41 and WCHPCO 18, initiating flow of the WF between said two parts across said WC according to “d”; when the ratio between pressures in said two parts is close to 1, opening said HPSDV 47, whereby using ISC according to “c”, across said WC, said two parts and said HPSDV 47;
2.8. combination of “a”, “b”, “c” for the ICE; according to “a”, after ending compression, opening said WCHPCO 18 and by diminishing said Vwc from Vec to Vmin, displacing at least a part of the WF to the HPC 8; according to “b”, additionally displacing to the HPC 8 with combustion inside the WC; according to “c”, during increasing Vwc from Vmin to a Begin Expansion Volume (Vbe), displacing another part of the WF from said HPC 8 to WC, using inertial flow of the WF inside said HPC 8, to avoid mixing between input flow to said WC and output gas from said WC; heating a part of the WF inside said HPC 8 before inputting this part to the WC; closing said WCHPCO 18, and then, optionally initiating additional combustion in the WC.

3. The method of claim 2, for the Internal Combustion Engine (ICE) of oscillating piston type with crankshaft, while using atmosphere as the LPC 40, further comprising: further providing in the HPC 8 of the heat machine, an input mean, named HPCIM 26, that includes a channel between said WCHPCO 18 and said HPC 8, the channel arranged with gradual increase in a transverse section from said WCHPCO 18 to said HPC 8; further providing in the heat machine, a sensor, named WCHPCIMDPS 28, arranged to measure a differential pressure between said WC and said HPCIM 26; after end compression, when a pressures in said WC and said HPCIM 26 are approximately equivalent, opening said WCHPCO 18 and displacing a part of the WF from said WC to HPCIM 26 by diminishing said Vwc; displacing an additional part of the WF from said WC to said HPCIM 26 by injection and combustion fuel into a part of the WF that is far from said WCHPCO 18, this part named a heating part of the WF, and due to heat expansion of said heating part, pushing said additional part, that is near said WCHPCO 18, into said HPCIM 26; further providing a temperature sensor inside said HPCIM 26, this sensor HPCIMTS 27 is arranged to measure a temperature of the WF in said HPCIM 26; regulating at least a time point when combustion begins in said heating part, this time point named Time Begin Heating (TimeBH), such that said temperature in said HPCIM 26 will be sufficiency smaller than the temperature of said heating part when combustion ends, with calculating or measuring this temperature by any way; after displacing a desired part of the WF from said WC, closing said WCHPCO 18 to begin expansion; selecting a working method from the group, consisting of:
a. selecting said Vec approximately equivalent to Vmin, and displacing said WF mostly by heat expansion of said heating part, whereby will be near zero moving of said piston under pressure HP;
b. selecting Vec>Vmin, and displacing the WF mostly by diminishing the Vwc, performing combustion mostly when said WCHPCO 18 is closed, whereby part of the WF having temperature slightly exceeds Tec, will be displaced to said HPC 8;
c. compromises between cases “a” and “b”, with Vec>Vmin and begin combustion before closing said WCHPCO 18;
d. ending combustion after closing said WCHPCO 18, whereby summed work of the cycle in said WC may be more than zero, even if Vbe=<Vec;
e. adjusting Vbe>Vec;
f. combination of “d” and “e”;
g. selecting said Volumetric Compression Ratio (VCR) such that Pec<HP, then heating WF in approximately constant volume Vec, and when a pressure in said WC increases to HP or exceeds HP, opening said WCHPCO 18;
h. any combination from a, b, d, e, g;
further providing an expander 19, with an input from said HPC 8, and an output to said LPC 40 and arranging a volumetric ratio of the expander 19 such that pressure at the end of expanding in the expander 19 will be approximately equivalent to said LP; using the expander 19 as a source for at least a part of output power of the engine, while regulating the expander according to demands of a load; the expander is selected from the group, consisting of:
3.1. the expander 19 without combustion in it;
3.2. the expander 19 with combustion in it;
3.3. the expander 19 with injection and fuel combustion, to maintain approximately constant temperature during at least a part of expansion;
further providing an Expander Input Heater (EIH) as a part of the HPC 8, to heat the WF that goes to the expander 19, where the EIH is selected from the group, consisting of:
3.4. the EIH including a heat exchanger 23 for heating the WF from output gas of the expander;
3.5. the EIH including a heat exchanger for heating the WF from output gas of the WC;
3.6. the EIH including a heat exchanger for heating the WF from external source;
3.7. the EIH including a part with fuel combustion inside the WF, preferably the part arranged with at least two envelopes, with combustion in internal envelope and surrounding volume connected to a part of the HPC 8 with relatively smaller temperature of the WF, whereby to diminish loss of heat;
3.8. any combination of 3.4-3.7;
further providing in the heat machine a pressure sensor HPCPS 32, arranged to react to said HP in said HPC 8; for further regulating a ratio between throughputs of the expander 19 and the WC, with regulation of a cycle speed of the WC according to feedback from said HPCPS 32, such that pressure in said HPC 8 will be approximately equivalent to desired HP; further providing in the heat machine a pressure sensor WCLPCDPS 33, for measuring a differential pressure between said WC and LPC 40; controlling a time for ending closing said WCHPCO 18, while using feedback from the WCLPCDPS 33, such that at expansion to said Vee, pressure in said WC will not be smaller than the LP in said LPCIP; further providing in the heat machine a WCLPOM 21, arranged as a controllable opening from the WC to the LPCIP, and an WCLPIM 20, arranged as a controllable opening from the LPCOP to the WC; opening the WCLPOM 21 when expansion of the WC reaches Vee, Pee, with Pee>=LP, and when pressure inside the WC diminish to LP, opening WCLPIM 20, whereby to initiate ISC between the WC and LPC 40; optionally, providing a blower 9LP, arranged for scavenging between WC and LPC 40.

4. The method of claim 2, for the External Heating Engine (EHE), initiating ISC by changing the volume of the WC (Vwc); further providing the following means: WCHPCO 18, WCHPIM 41, HPCIM 26, WCHPCIMDPS 28, expander 19, HPCPS 32, WCLPCDPS 33, WCLPOM 21, WCLPIM 20; further providing in the IPC 8 of the heat machine an output mean HPCOM 44, that includes a channel between the IPC 8 and the WCHPIM 41, said channel arranged with gradually decreasing transverse section from said HPC 8 to WCHPIM 41, whereby to diminish loss of kinetic energy of the WF; further providing in the heat machine, a sensor WCHPCOMDPS 43, arranged to measure differential pressure between said WC and HPCOM 44; after ending compression, when the pressure in said WC is approximately equivalent to pressure in said HPCIM 26, opening said WCHPCO 18 and continuing diminishing said Vwc according to signal from said WCHPCIMDPS 28, whereby initiating flow of the WF from said WCHPCO 18 to said HPCIM 26; when pressure in the WC will be approximately the same or smaller than the pressure in said HPCOM 44, begin opening said WCHPIM 41 according to signal from said WCHPCOMDPS 43, whereby to begin ISC; ending closing said WCHPIM 41 and WCHPCO 18 when said Vwc will be approximately equivalent to said Vbe; further regulating a ratio between throughputs of the expander 19 and the WC, with regulation of a cycle speed of the WC according to feedback from said HPCPS 32, such that the pressure in said IPC 8 will be approximately equivalent to desired HP; further controlling a time for closing said WCHPCO 18 using feedback from the WCLPCDPS 33, such that after expansion to said Vee, pressure Pee in the WC will exceed the LP in said LPCIP; opening the WCLPOM 21 after expansion the WC to said Vee, Pee>LP, and when pressure inside the WC diminish to LP, opening WCLPIM 20, whereby initiating ISC between the WC and LPC 40; optionally, providing a blower for scavenging between WC and LPC 40.

5. The method of claim 2, for said External Combustion Engine (ECE), further providing WCHPCO 18, WCHPIM 41, HPCIM 26, WCHPCIMDPS 28, expander 19, HPCPS 32, WCLPCDPS 33, WCLPOM 21, WCLPIM 20, HPCOM 44, WCHPCOMDPS 43; further providing in the IPC 8 of the heat machine a Single Direction Valve (HPSDV, 47), for separating the IPC 8 to an input part (HPCIP), that includes said HPCIM 26, and an output part (HPCOP), that includes said HPCOM 44, the HPSDV 47 arranged to make directional flow of the WF inside the IPC 8 across said HPSDV 47 from said HPCIP to HPCOP, with a small pressure drop dP; directly controlling the HPSDV 47 by the dP, or by a driver, activated by a differential pressure sensor, for measuring the dP; after ending compression, begin opening said WCHPCO 18 and WCHPIM 41 according to signals from said WCHPCIMDPS 28 and WCHPCOMDPS 43; at the same time or a-little before that, opening said WCHPIM 41, to begin combustion in a part of the WF inside HPCOP, being near HPSDV 47, and pushing a part of the WF, heated in previously cycle in said HPCOP, to said WC across said WCHPIM 41, and and pushing the WF from said WC across said WCHPCO 18 to said HPCIP; if increasing of the heating volume of the WF is smaller than volume that must be scavenged, using this increasing to initiate ISC, which begins when said HPSDV 47 is open, with circulation across a closed loop including said HPSDV 47, HPCOP, HPCOM 44, WCHPIM 41, WC, WCHPCO 18, HPCIM 26, HPCIP; closing said WCHPIM 41, WCHPCO 18 to end scavenging; further controlling a time for closing said WCHPIM 41, WCHPCO 18, using feedback from said WCLPCDPS 33, such that after expansion to said Vee, pressure in said WC, Pee, will exceed said LP in said LPCIP; regulating a ratio between throughputs of said expander and said WC, with regulating a cycle speed of said WC according to feedback from said HPCPS 32, such that pressure in said IPC 8 will be approximately equivalent to the desired HP; opening the WCLPOM 21 after expansion the WC to said Vee, Pee>LP, and when pressure in said WC diminish to said LP, opening said WCLPIM 20, whereby to initiate ISC between said WC and LPC 40; optionally, providing a blower, arranged for scavenging between said WC and LPC 40.

6. The method of claim 2, for the EHE, with scavenging at least by changing of an external volume that is not volume of the WC, further providing said WCHPCO 18, WCHPIM 41, expander 19, HPCIM 26, HPCIMTS 27, HPCPS 32, HPCOM 44, WCHPCOMDPS 43, HPSDV 47, HPCIP, HPCOP; using the expander 19 of positive displacement type, the input of which is connected between said HPCIP and HPSDV 47; further providing phase difference sensors, arranged to detect difference between cycle phases of said WC and expander 19; performing synchronization between cycles of said WC and said expander 19, using signals from said HPCPS 32 and from said phase difference sensors, such that pressure in said HPC 8 will be approximately as desired, and after ending compression in said WC, at least a part of an input stroke of said expander 19 occurs; after ending compression in said WC, opening said WCHPCO 18 and WCHPIM 41, initiating scavenging flow of said WF from said HPCOP across said HPCOM 44, WCHPIM 41, WC, WCHPCO 18, HPCIM 26, HPCIP; adjusting the optimal scavenging duration, that take place when temperature T27, measured by said HPCIMTS 27, exceeds the temperature at end compression Tec, calculating Tec for appropriate adiabatic process which begins compression temperature Tbc; to increase the scavenging duration, caused by said expander 19, and so increasing T27, using Inertial Scavenging ISC, with opening said HPSDV 47 and circulation said WF across loop including said HPSDV 47, HPCOP, HPCOM 44, WCHPIM 41, WC, WCHPCO 18, HPCIM 26, HPCIP; closing said WCHPIM 41, WCHPCO 18 to end scavenging.

7. The method of claim 2, for the heat pump, with scavenging at least by changing of an external volume, that is not volume of the WC; the HPC 8 arranged for cooling the WF by a heat transfer to the external medium; further providing said WCHPCO 18, WCHPIM 41, HPCIM 26, HPCIMTS 27, HPCPS 32, HPCOM 44, WCHPCOMDPS 43, HPSDV 47, HPCIP, HPCOP; further providing a compressor 7 of positive displacement type, with input from said LPC 40, output to said HPC 8 and a pressure ratio approximately equivalent to HP/LP; using the compressor 7 as a receiver for at least a part of the input power of the heat pump; further providing additional heat exchanger 53 arranged for cooling the WF from output of the compressor 7, connecting the output of this heat exchanger 53 to said HPCOP, between said HPSDV 47 and HPCOM 44; further providing phase difference sensors, arranged to detect difference between cycle phases of said WC and compressor 7; performing further synchronization between cycles of said WC and said compressor, using signals from said HPCPS 32 and said phase difference sensors, such that pressure in said HPC 8 will be approximately as desired, and after ending compression in said WC, at least a part of an output stroke of said compressor 7 occurs; after ending compression in said WC, opening said WCHPCO 18 and WCHPIM 41, so at least during a part of said output stroke, and when said HPSDV 47 is closed, moving at least a part of said WF from said compressor 7 to said HPCOP, and moving a part of the WF across said HPCOM 44, WCHPIM 41, WC, WCHPCO 18, HPCIM 26, to said HPCIP; adjusting the optimal scavenging duration, that take place when said temperature T27, measured by said HPCIMTS 27, will be a-little smaller than temperature at end compression Tec; calculating Tec for appropriate adiabatic process with begin compression temperature Tbc; using Inertial Scavenging (ISC), with opening said HPSDV 47 and circulation said WF across loop including said HPSDV 7, HPCOP, HPCOM 44, WCHPIM 41, WC, WCHPCO 18, HPCIM 26, HPCIP, to increase the scavenging duration and diminish said T27; closing said WCHPIM 41, WCHPCO 18 to end scavenging.

8. The method of claim 2, for a heat engine, with scavenging between said WC and HPC 8 by a blower 9HP, and scavenging between said WC and LPC 40 by a blower 9LP, each blower is arranged as a rotating mean, capable of working as a turbine or as a compressor according to the difference of pressure between input and output of said mean, said mean connected to electrical machine that works as electrical generator or electrical motor and connected to an electrical accumulator across electrical controller; further providing said LPCIP, LPCOP, WCHPCO 18, WCLPOM 21, WCLPIM 20, WCHPIM 41, expander 19, HPCIM 26, WCHPCIMDPS 28, WCLPCDPS 33, HPCPS 32, WCHPCOMDPS 43; placing blower 9HP after the WCHPCO 18 placing blower 9LP between the WCLPOM 21 and LPCIP; when according to signal from the WCHPCIMDPS 28, pressure in the WC will be no smaller than pressure in the HPCIM 26, opening the WCHPCO 18; then when according to signal from the WCHPCOMDPS 43, pressure in the WC will be no more than pressure in the HPCOM 44, opening the WCHPIM 41, whereby scavenging by said blower 9HP; when according to signal from the WCLPCDPS 33, pressure in the WC will be no smaller than pressure in the LPCIP, opening the WCLPOM 21; then when according to signal from the WCLPCDPS 33, pressure in the WC will be no more than pressure in said LPCOP, opening the WCLPIM 20, whereby performing scavenging by said blower 9LP; defining difference dLP between pressures in said LPCOP and LPCIP by experiment, and using the dLP for fine controlling of said WCLPOM 21 and WCLPIM 20; further matching between throughputs of said WC and said expander 19, using signal from said HPCPS 32, so that pressure in said HPC 8 will be approximately as desired.

9. Oscillating piston type Positive Displacement Heat Machine (PDHM), with at least one cylinder and at least one piston, oscillating in said cylinder between two Dead Points (DPs) at which said piston changes direction, the DP at a High Pressure level HPDP, and the DP at a Low Pressure level LPDP; the PDHM include means, for converting linear movement of said piston to rotation of at least a single mean, named a crankshaft, and vice versa, to convert rotation of said crankshaft to linear movement of said piston;
characterized in that is further comprises:
at least one: Rotating position and Speed Sensor (RSS), arranged to measure a rotation angle and a rotation speed of the crankshaft; Energy Source (ES), arranged to send regulated energy to said piston and other Moving Parts (MP), connected to it and to said crankshaft; Energy Receiver (ER), arranged to receive a regulated energy from said MP; Kinetic Energy Controller (KEC), arranged for regulating a kinetic energy of said MP, such that the kinetic energy near the same type DP is changed between two cycles approximately to a desired value, named Acceleration Between Cycles (ABC), while using for this regulation said ES, ER and feedback from said RSS, said regulation include possibility for reducing the rotation speed approximately to zero at least near one of said DP; Fixation of Crankshaft (FC), arranged as a mean to fixate the crankshaft near at least one of said DP if the rotation speed near this DP is approximately zero; Initiator of Crankshaft Moving (ICM), arranged as a controllable energy source to initiate rotation of the crankshaft, the ICM is controllable by said KEC; any of said RSS, ES, ER, KEC, FC, ICM may be combined with any other from them or arranged with combined functions of them and may be any type; the improvement for possibility for working with Pulse Pause Modulation (PPM) of the crankshaft speed.

10. An engine according to claim 9, further comprising: a Hydraulic Accumulator (HA) with separate changeable volumes for a liquid and for a compressed gas, with the same high pressure and being inside a common envelope, arranged to stand against this high pressure; a Low Pressure Liquid Volume (LPLV); a Hydraulic Motor Pump (HMP), connected between said HA and LPLV, arranged for driving a vehicle or another load and to push the liquid to said HA, whereby to restore energy of the vehicle; a buffer 51, arranged as a combination of a First Energy Source and a First Energy Receiver, the buffer arranged to accumulate at least a part of energy of a working stroke and to return said part to a compression stroke of said ICE, said buffer selected from the group, consisting of:
a. a hydraulic cylinder, connected to a second Hydraulic Accumulator;
b. a pneumatic cylinder, connected to a pneumatic buffer;
c. a spring;
d. an electrical accumulator, controller and electrical machine, arranged to work as electrical motor during at least a part of said compression stroke, or as a generator during at least a part of said working stroke of said ICE;
e. any combination from a, b, c, d;
a second energy receiver, arranged as a hydraulic pump with a valve, controllable by said KEC and connected to said LPLV, and with an automatic output valve, connected to said HA; said controllable valve is open during input stroke of said hydraulic pump and then during a part of output stroke according to power that is needed from said hydraulic pump, said power is defined by said KEC; said buffer and the second energy receiver are connected to said piston of said ICE.

11. A method of operating a Heat Machine (HM) being a heat engine or a heat pump; the HM is provided with at least a single High Pressure Chamber (HPC, 8) and with at least a single Low Pressure Chamber (LPC, 40); the LPC may be atmosphere; the HM is provided with Energy Conversion Means (ECM), arranged for conversion algebraic sum of compression and expansion energy at least of a part of said WF to mechanical work, or vice versa; the ECM may be positive displacement type, and this case the ECM named Working Chamber (WC); part of the WC named WCC 35, being arranged only for compression; part of the WC named WCE 34, being arranged only for expansion; the WC may include separated parts WCE 34 and WCC 35, or arranged as at least a single chamber for compression and expansion; the ECM may include a turbine, for converting energy of compressed WF to kinetic energy of moving WF and then to mechanical work; the ECM may include an axial or radial compressor; the turbine, mechanically connected to any compressor (radial, axial, positive displacement or another) named turbo-compressor; the ECM may include combinations of any type WC, turbine, compressor, with at least a single stage for compression and at least a single stage for expansion; said Heat Machine (HIM) is working with a thermodynamic cycle, comprising:
displacing at least a part of the WF between said ECM and said LPC 40;
displacing at least a part of the WF between said ECM and said HPC 8;
performing compression and expansion at least inside said ECM;
changing heat energy of the WF by any way;
characterized in that it further comprises the steps of:
providing at least a single expander 19 or compressor 7, the expander or compressor arranged with at least a single stage, arranged without transferring a work from or to said ECM; connecting said expander 19 or compressor 7 between at least a single HPC 8 and at least a single LPC 40; arranging an expansion ratio of an expander and a compression ratio of a compressor which are approximately equivalent to the ratio of pressures between appropriate HPC and LPC; regulating the ratio between throughputs of said expander 19 or compressor 7 and the ECM, so that said pressure HP will be approximately as desired; using said expander as an output of at least a part of power from said engine, or using said compressor as an input of at least a part of power for said heat pump.

12. A method according to claim 11, further comprising: providing at least a single WCC 35 and at least a single LPC 40, being atmosphere, and so said LP is approximately equivalent to atmospheric pressure; compressing atmospheric air in said WCC 35 and displacing this compressed air with temperature Tec to said HPC 8; providing at least a single WCE 34, the WCC 35 and WCE 34 are reciprocating piston type, with separated cylinders for the WCE 34 and WCC 35; providing a regenerator, that includes at least a part of HPC 8 and of LPC 40; heating the air in the regenerator with begin heating parameters HP, Tec, using for this heating heat energy of a gas with parameters LP, Tee>Tec, that go from the outputs of said WCE 34 and said expander 19; sending in said regenerator cooled gas with parameters LP, Tout>Tec, from said regenerator to atmosphere, or to means, arranged for using heat energy of this cooled gas; expanding in the WCE 34 and in the expander 19, air, heated in said regenerator; during this expanding, injecting fuel into the WCE 34 and into the expander 19, such that at least a part of expanding will be approximately with constant temperature; providing at least a single beam; and pistons of the WCC 35 and WCE 34 connected to the beam; ensuring symmetrical distribution of forces, applied to the beam; said beam includes bearings connected to connecting rods, another sides of said rods with another bearings connected to crankshafts, while loading them with the same symmetrical forces; where no normal forces are applied to the cylinder, due to symmetrical structure with synchronization of crankshafts, such that crankshafts are rotating in opposite directions; diminishing loads on crankshafts by using at least a part of expansion energy from the WCE 34, for compression in the WCC 35; further diminishing loads on crankshafts by increasing summed kinetic energy of said beam, rods, pistons and other reciprocating parts, connected to them, relatively to summed kinetic energy of said crankshafts and other rotating parts, connected to them, and parts, used for said synchronization; regulating valves of the WCE 34 such that beginning output from said WCE 34 will be near the end of the expansion stroke and the pressure at end expansion will be near said LP; for this regulation, adjusting a time, when an input valve of the WCE 34 is open, the optimal value of this time named below an optimal time; providing a pressure sensor HPCPS 32; using said expander 19 as main energy output from the ICE, while regulating the ratio between throughputs of said expander and the ECM by regulating a mean rotation speed of said ECM according to feedback from said HPCPS 32, while increasing the speed when said HP is smaller than desired, and vice versa; if increasing said mean rotation speed is needed, increasing the time when an input valve of the WCE 34 is open, and vice versa, were in both cases, returning said time to said optimal time when said mean rotation speed is near the desired value.

13. A Positive Displacement Heat Machine with multi vane Rotor (PDHMR), that may be the heat engine or the heat pump, comprising: at least a single LPC 40 and least a single HPC 8; at least a single body 1 with left and right walls 14 and a rotor 2 between them; a plurality of vanes 3, being movable approximately along radius of said rotor 2; several working chambers (WC), each WC is formed by Surfaces of neighboring Vanes 3 (SV), parts of Surfaces of said Left and Right Walls 14 (SLRW), a part of Surface of said Body 1 (SB), and a part of Surface of said Rotor 2 (SR); wherein during rotation of said rotor 2, volume (Vwc) of every WC is changing between Vmin and Vmax; a space, enclosed between the SLRW, SB, SV, SR, where the Vwc is diminished to Vmin, named a High Pressure Space (HPS); a space, enclosed between the SLRW, SB, SV, SR, where the Vwc is increased to said Vmax, named a Low Pressure Space (LPS); at least a single Low Pressure Output Mean (WCLPOM, 21) and a Low Pressure Input Mean (WCLPIM, 20), both arranged as controllable openings between LPS and said LPC 40; means 9 for scavenging the WF between said LPS and said LPC 40; at least a single High Pressure Controllable Opening (WCHPCO, 18) provided between said HPS and HPC 8; where openings WCLPOM 21, WCLPIM 20, WCHPCO 18 are controlled, preferably be due to changing position of every WC relatively to appropriate opening;
characterized in that is further comprises:
means, arranged to initiate displacing at least a part of the WF between said HPC 8 and said WC, when being HPS, at least across said WCHPCO 18, such that displacement of said part is not caused by changing the volume of the WC.

14. The PDHMR according to claim 13, further comprising: a High Pressure Separator (HPSEP, 5), arranged to separate said HPS to an input and output parts, such that during moving said WC across said HPS, the volume of the input part is increases, and the volume of the output part diminishes, such that the changing in the volume of the HPS is relatively small; Separated HP Scavenging Window 12, that is separated by said HPSEP 5 to an input and output windows in a part of said body 1, enclosing said HPS, said output window is equivalent to said WCHPCO 18 and connected to the input of said HPC 8, and said input window is connected to the output of said HPC 8; a driver 6, arranged to move the HPSEP 5 approximately along radial direction with synchronization to rotation of said rotor 2 and with a small gap to said SR, such that the surface of the gap will be sufficiency smaller than the surface of said Scavenging Window 12; the SR is arranged with smooth changes of a radial distance to the rotation center, said distance is maximal near the tips of said vanes 3, and minimal between vanes 3; LP Scavenging Window 11 in part of said body 1, enclosing said LPS, said LP Scavenging Window 11 is equivalent to said WCLPOM 21, WCLPIM 20.

15. The method according to claim 11, wherein the heat pump is provided with at least single HPC 8 and at least single LPC 40, further comprising: providing at least the single Working Chamber (WC), including at least a single reciprocating piston and at least a single crankshaft, said WC is arranged for conversion of the algebraic sum Zwork of compression and expansion work at least of a part of the WF to mechanical work, or vice versa, the WC arranged for regulating said Zwork is near zero; providing in the WC, said controllable openings WCLPIM 20, WCLPOM 21, WCHPCO 18, WCHPIM 41; providing a hot and cool zones in the LPC 40, the hot zone is caused by heating from cooling objects; the HPC 8 is provided with a hot input and a cold output, where cooling in the HPC is caused by thermal transfer to any external medium; said heat pump is working according to the following cycle:
after ending expansion in said WC, opening said WCLPOM 21 and WCLPIM 20 and performing LP scavenging the WF from said hot zone of LPC 40 across said WCLPIM 20, WC, WCLPOM 21 to said cool zone of LPC 40;
compressing the WF in said WC to said HP;
performing HP scavenging of the compressed WF from said cool output of HPC 8 across said WCHPIM 41, WC, WCHPCO 18 to said hot input of HPC 8;
performing adiabatic expanding of the compressed WF in said WC, to said LP;
regulating a compression and expansion ratio of the WC according to desired Low Temperature (LT); regulating a cycle speed of the WC according to desired throughput; providing at least a single stage compressor 7, arranged without transferring a work from, or to, said WC; arranging compression ratio of the compressor 7 to be approximately equivalent to HP/LP; connecting the input of said compressor to said hot zone of LPC 40; providing a cooling tube 53, arranged to supply the WF from the output of the compressor to said HPC 8, while cooling the WF in the cooling tube 53 by heat transfer to an external medium; connecting said compressor to an energy source, selected from the group, consisting of: a. wind turbine; b. engine powered by water; c. electrical motor; d. heat engine; e. animal; f. any combination from a, b, c, d, e; providing a pressure sensor HPCPS 32, arranged to react to said HP inside said HPC 8; regulating a ratio between throughputs of the compressor 7 and the WC, with regulation of throughputs of the compressor 7 according to feedback from said HPCPS 32, such that pressure in said HPC 8 will be approximately equivalent to desired HP; providing a LP blower 9LP, for said LP scavenging; selecting an HP scavenging from the group consisting of:
15.1. providing an HP blower 9HP, opening said WCHPIM 41 and WCHPCO 18 to begin HP scavenging and closing them to end HP scavenging;
15.2. synchronization of the HP scavenging to the output stroke of the compressor 7, being a positive displacement compressor; separating the HPC 8 to two parts with approximately equivalent volumes by the Single Direction Valve (HPSDV, 47) between them; connecting the output of said compressor 7 to a cooling tube 53 and connecting the output of said cooling tube 53 between said HPSDV 47 and said WCHPIM 41; when said HPSDV 47, and WCHPIM 41, and WCHPCO 18 are closed, increasing the pressure before said WCHPIM 41, using said synchronization HP scavenging to the output stroke of the compressor 7; after beginning increasing the pressure, opening said WCHPIM 41 and WCHPCO 18, initiating a flow of the WF between said two parts across said WC; when the ratio between pressures in said two parts will be near 1, opening said HPSDV 47, whereby using Inertial Scavenging (ISC) across said WC, said two parts and said HPSDV 47; closing said WCHPIM 41 and WCHPCO 18 to end HP scavenging;
15.3. using ISC, which is initiated by opening said WCHPCO 18 after end compression, while continuing diminishing the volume Vwc of the WC; when said Vwc will be close to Vmin and inertial of flow in said WCHPCO 18, causing diminishing of the pressure in said WC to be below the pressure before said WCHPIM 41, open WCHPIM 41 and continuing with ISC; closing said WCHPIM 41 and WCHPCO 18 to end HP scavenging.

16. The method of claim 15, further comprising: providing a distributor 50 of the WF, with an input connected to the output of the compressor, the distributor 50 is arranged to controllably divide the input flow of the FW between a first and a second outputs of the distributor 50, the first output connected to said cooling tube 53; providing a thermal isolated tube 24, connected to the second output, another tip of this tube 24 connected to a thermal isolated buffer volume 8B; providing an expander 19, with an input connected to the buffer volume 8B across controllable on/off valve 54, and mechanical output of the expander 19 connected to electrical generator 46; controlling the distributor 50 and the on/off valve 54 such that when a compressor power, caused by power of wind, is more than needed for the heat pump, the compressor 7 producing an overpower, part of the compressed WF is directed to the buffer volume 8B and the expander send said overpower to the electrical generator.

17. The method according to claim 11, for operating an electrical plant with heating at least from concentrated Sun rays, wherein a heater 8SH placed in focus of an optical concentrator, further comprising: providing at least a single electrical generator 46, arranged to convert mechanical energy to electrical energy; providing a Temperature Sensor (TSHT, 42), arranged to measure the HT; providing a pressure sensor HPCPS 32, arranged to react to said HP inside said HPC 8; placing the HPC 8 near a heater, that is arranged to heat the FW in the HPC, and placing the WC near the HPC 8; said TSHT 42, HPC 8, WC being a Near Heater Means (NHM); regulating the Zwork near zero by regulation valves of the WC; placing the LPC 40, expander 19 and electrical generator 46 as far from the heater 8SH as needed, to avoid shading the optical concentrator from Sun rays; said LPC 40, expander 19, electrical generator 46, being a Remote Means (RM); connecting the input of the expander 19 to said HPC 8 with a thermal isolated tube 24; placing connections between said RM and NHM, such that this connections are shaded by said thermal isolated tube 24, or vice versa, whereby to avoid additional shading of the optical concentrator; mechanically connecting said expander 19 to said electrical generator 46; regulating the throughput of the WC according to the received heat, such that said HT, measured by said TSHT 42, will be near a desired optimum; regulating a throughput of the expander 19 according to said HP, while increasing the throughput of the expander if the HP is more than desired, and vice versa, measuring said HP by said HPCPS 32; regulating the throughput by the following group, consisting of:
a. regulating the input and output valves of the expander 19;
b. using at least a single additional working volume, by connecting or disconnecting said working volume from a main shaft of the expander 19;
c. using at least two expanders 19 and two electrical generators 46, each expander connected to appropriate electrical generator, and connecting or disconnecting expanders to said HPC 8 and LPC 40 according to desired summed throughput, with appropriate connecting and disconnecting electrical generators from electrical load;
d. using the mechanical connection between the expander 19 and electrical generator 46 with controllable transmission;
e. using the expander 19 with regulating working volume;
f. any combination between a-e;
further matching the electrical power of the electrical generator 46 to the mechanical power of the expander 19 by regulating the electrical load; further placing the Sun heater 8SH inside the thermal isolated chamber with a window, that is approximately normal to optical axis of the Sun concentrator, and arranging that the receiving surfaces of the Sun heater 8SH are sufficiency larger than the surface of said window, thereby placing most of receiving surfaces not in parallel to said window.

18. The method of any one of claims 3-8, 12, 15-17, wherein the PDHM is an oscillating piston type with at least a single piston and a single crankshaft; further providing: at least one Rotating Speed Sensor (RSS), at least one controllable Energy Receiver (ER), at least one controllable Energy Source (ES), at least one Fixation of Crankshaft (FC), at least one Initiation of Crankshaft Moving (ICM), and at least one Kinetic Energy Controller (KEC); arranging the KEC for regulating the throughput of the WC, according to feedback from said HPCPS 32, such that pressure in said HPC 8 will be approximately equivalent to a desired HP, by changing an Acceleration Between Cycles (ABC), so that ABC>0 for acceleration, ABC<0 for deceleration; regulating, according to signal from said RSS, kinetic energy of said Moving Parts (MP) by said KEC, such that when said piston is near a Dead Point (DP), the speed of said crankshaft, will be near a desired local minimum, including approximately zero; if the speed is near zero, optionally performing fixation of said MP near this DP by said FC, and after a Time of Pause (TimeP), initiating rotation by said ICM; regulating a value of the local minimum and TimeP according to the feedback from said HPCPS 32 using said KEC, with feedback from said RSS and controlling the distribution of the energy between said ES and ER; further using mentioned regulations of the local minimum and TimeP, to control a time for displacing the WF between said WC and HPC 8 and between said WC and LPC 40, and to control power from zero to maximum, and to control the throughput of the WC; wherein any of said RSS, ES, ER, KEC, FC, ICM may be combined with any other from them or arranged with combined functions of them and may be any type, including using kinetic energy of any part, thereby allowing working with Pulse Pause Modulation (PPM).

19. A two stroke reciprocating piston engine apparatus, comprising:
a) at least single thermally isolated High Pressure Chamber (HPC) 8 with Working Fluid (WF) compressed to High Pressure (HP), volume of said HPC 8 is sufficiency more, than end compression volume Vec;
b) at least single Cylinder 15 with two Assemblies 16, each Assembly includes:
b.1) two Crankshafts having minimal Inertial Moment, each Crankshaft is not connected to external load;
b.2) a Piston, connected to a central part of a Beam;
b.3) a Buffer 51, connected to central part of the Beam opposite to the Piston, for accumulating Energy from Expansion (EE) of WF (gas) during working stroke of said Piston, and return the EE during compression stroke as Energy for Compression (EC), while EE and EC are approximately the same, EE=EC;
b.4) two connecting rods, one side of every connecting rod connected with bearing to a tip of the Beam, and another side with another bearing connected to corresponding Crankshaft being connecting to a synchronization gear; the crankshafts are arranged to rotate to opposite directions due to said gears; at least one of said crankshafts with addition gear and synchronization Belt connected to corresponding crankshaft of another said Assembly;
c) said two Assemblies 16, are arranged such, that:
c.1) symmetrically moving each of said two Pistons inside said Cylinder 15 between High Pressure Dead Point (HPDP), that is near a central part of Cylinder 15, and a Low Pressure Dead Point(LPDP), that is near a tip of Cylinder 15, so in Cylinder 15 there are two said HPDPs and two said LPDPs;
c.2) symmetrically moving all parts, such that inertial forces are balanced;
c.3) symmetrically loading all parts by gas forces, such that there are no forces between said pistons and Cylinder 15;
c.4) volume (Vmin) between said two HPDP is equivalent or smaller than said Vec, such that said pistons are not displacing all compressed WF to said HPC 8, thereby diminishing moving pistons under said HP;
c.5) Assemblies 16 and all rotating means in it or connected to it, including said Belt, have a minimum Inertial Moment, limited only by mechanical strength, but the Reciprocating Parts in the Assemblies 16 may have a large mass, thereby diminishing dynamic load on said bearings;
d) a Working Chamber High Pressure Controllable Opening (WCHPCO) 18 in said central part of Cylinder 15, between two said HPDP, the WCHPCO 18 arranged to control a flow of WF between said Cylinder 15 and HPC 8, such that:
d.1) said flow begins after ending compression and when the pressure in Cylinder 15 is approximately equivalent to said HP;
d.2) said flow ends when volume in said Cylinder 15 is increased to Vbe, and Vbe is equivalent or more than said Vec;
e) a fuel Injector 25A between two said HPDP, remote from said WCHPCO 18; said Injector 25A arranged for combustion after end compression, such that:
e.1) after opening said WCHPCO 18, displacing at least a part of compressed WF to said HPC 8 due to heat expansion of combusted product, thereby diminishing moving of said Piston under said HP;
e.2) minimum mixing between said displacing part and said combusted product;
e.3) preferably ending combustion before expanding to said Vbe;
f) a sensor HPCIMTS 27, arranged to measure temperature T27 of the WF in the HPC 8 after said WCHPCO 18;
g) a Remote Expander 19, arranged as power output of the engine, without transferring energy from, or to, Assembling 16, with expansion from said HP to Atmospheric pressure;
h) at least a single Electrical Machine 22, mechanically connected to any of said Crankshafts, for receiving energy, for providing energy, arranged to control rotation of said Crankshafts, the power of said Machine 22 is sufficiency smaller, than the power of said Expander 19;
i) a Rotating Speed and position Sensor (RSS) 31, mechanically connected to said Electrical Machine 22 or to the Crankshaft;
j) a pressure sensor HPCPS 32, arranged to measuring differential pressure between HPC 8 and Atmosphere;
k) a Controller 29, arranged to:
k.1) control said WCHPCO 18 and Injector 25A, such that EE=EC, with using feedback from said RSS 31;
k.2) control said WCHPCO 18 and Injector 25A, such that if need fast changing of mean speed of said Crankshaft, EE>EC, or EE<EC according to desired changing;
k.3) control said Electrical Machine 22, such that kinetic energy of said Assembling 16 at position according to at least one of said HPDP or LPDP, will be desired volume, including zero, with using for this control feedback from said RSS 31;
k.4) if the speed of said Crankshaft near at least one of said HPDP or LPDP is near zero, optionally fixating said Assembling 16 during desired Fixation Time, using said Electrical Machine 22 for this fixation;
k.5) initiating moving of said Crankshaft with said Electrical Machine 22;
k.6) synchronization the mean cycle speed of Assembling 16 with throughput of said Expander 19, such that the pressure HP in said IPC 8, measured by said HPCPS 32, will be as desired;
k.7) controlling said Injector 25A and WCHPCO 18 for minimum mixing, mentioned in e.2, with using signal from said RSS 31 and HPCIMTS 27; for optimal case, T27 is not sufficiency more, than temperature at end compression Tec;
k.8) controlling said Injector 25A and WCHPCO 18, such that pressure at the end expansion will be not substantially more than Atmospheric pressure;
1) at least a single Fuel Injector 25B, preferably inside said IPC 8, and optionally in Expander 19.
